(19) United States
(12) Patent Application Publication
(10) Pub. No.: US 2026/0240153 A1
(43) Pub. Date: Aug. 20, 2026

(54) ORGANIC INSECTICIDES BASED ON MINOR CANNABINOIDS

(71) Applicant: West Virginia University Board of Governors on Behalf of West Virginia University, Morgantown, WV (US)

(72) Inventors: Michael Gutensohn, Pittsburgh, PA (US); Bikash Deo, Morgantown, WV (US)

(21) Appl. No.: 19/543,928

(22) Filed: Feb. 19, 2026

Related U.S. Application Data
(60) Provisional application No. 63/760,155, filed on Feb. 19, 2025.

(51) Int. Cl. A01N 43/16; A01N 43/40; A01N 53/00; A01N 63/22; A01N 65/26; A01P 7/04

(52) U.S. Cl. CPC A01N 43/16; A01N 43/40; A01N 53/00; A01N 63/22; A01N 65/26; A01P 7/04

(57) ABSTRACT

In one aspect, the disclosure relates to pesticide compositions including minor cannabinoids as well as methods of treating and/or preventing damage to plants using the compositions. The minor cannabinoids can be used alone or in combination with one another or with another organic insecticide in the disclosed compositions and, in one aspect, may be particularly important for controlling beet armyworm, although they can be used to control any insect pest. The pesticide compositions can further include carriers, diluents, surfactants, and excipients to aid mixing, dispersal, storage, and/or other properties of the compositions.

### CROSS-REFERENCE TO RELATED APPLICATIONS

This application claims the benefit of U.S. Provisional Application No. 63/760,155 filed on Feb. 19, 2025, which is incorporated herein by reference in its entirety.

### BACKGROUND

Cannabis belongs to the Cannabaceae family and is a diploid plant with a chromosome number of n=10. It is a naturally dioecious plant, but today many feminized strains exist. These feminized seeds are produced by chemical treatment for commercial use. The flowers of female cannabis plants carry a high density of glandular trichomes which are the structures involved in the synthesis and storage of secondary metabolites such as cannabinoids and terpenes. There are two species of cannabis (Cannabis sativa and Cannabis indica). Cannabis sativa is mostly used for fiber and seed purposes while Cannabis indica is mostly used for recreational purposes as it has a higher concentration of tetrahydrocannabinol (THC) compared to sativa.

Cannabinoids are the secondary metabolites synthesized in the cannabis plant. All the cannabis strains grown today can be categorized into different strains or chemotypes depending on the dominant cannabinoid synthesized in them, including THC, cannabidiol (CBD), and fiber/seed chemotypes.

Excessive use of synthetic insecticides and pesticides is an integral part of modern crop production. The adverse effects of these chemicals on the environment are well documented and their potential effects on human health are a concern for farmers and consumers alike. Moreover, these synthetic insecticides and pesticides tend to persist in the soil and water for extended periods of time and appear to accumulate in natural food chains thus affecting many non-target organisms. Organic farming and more sustainable approaches such as integrated pest management (IPM) are ways to minimize the adverse effects of synthetic insecticides used in crop production. While a large number of consumers wish to buy fruits and vegetables from organic production, many can actually not afford the higher prices that are charged for organic produce. Organic crop production is more expensive because it is more labor intensive, has higher costs for insect and pest management, and ultimately lower yield and higher crop loss. This is in part due to the fact that only a few insecticides are certified for use in organic farming, like neem oil, nicotine, bacillus and pyrethrin-based insecticides. In consequence there is an urgent need for additional highly efficient organic insecticides that can be broadly applied.

Remarkably, in the last 100 years, there has been no discovery of new organic insecticides, with the commercialization of pyrethrin occurring in 1900. Despite advances in organic pesticide research, there is still a scarcity of plant-based compositions that are potent and effective organic insecticides and that do not cause adverse effects to the environment or human and animal health. These needs and other needs are satisfied by the present disclosure.

### SUMMARY

In accordance with the purpose(s) of the present disclosure, as embodied and broadly described herein, the disclosure, in one aspect, relates to pesticide compositions including minor cannabinoids as well as methods of treating and/or preventing damage to plants using the compositions. The minor cannabinoids can be used alone or in combination with one another or with another organic insecticide in the disclosed compositions and, in one aspect, may be particularly important for controlling beet armyworm, although they can be used to control any insect pest. The pesticide compositions can further include carriers, diluents, surfactants, and excipients to aid mixing, dispersal, storage, and/or other properties of the compositions.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows the cannabinoid biosynthesis pathway.

FIG. 2 shows major and minor cannabinoid biosynthesis pathways.

FIG. 3 shows a structural comparison among cannabinoids of varying alkyl chain lengths.

FIG. 4 shows an experimental workflow for an insect larva feeding assay useful in assessing insecticidal capacities of cannabinoids.

FIGS. 5A-5D show a weight comparison of beet armyworm larvae after 8 days of treatment. FIG. 5A; Larvae feeding assay of varinol cannabinoids. It was found four of the varinol cannabinoids Δ⁹-tetrahydrocannabivarinic acid (Δ⁹-THCVA), Δ⁹-tetrahydrocannabivarin (Δ⁹-THCV), Δ⁸-tetrahydrocannabivarinic acid (Δ⁸-THCVA), and Δ⁸-tetrahydrocannabivarin (Δ⁸-THCV) cause highly significant weight reduction in comparison to control and acetonitrile. FIG. 5B; Larvae feeding assay on butol cannabinoids. It was found that one butol cannabinoid Δ⁹-tetrahydrocannabutol (Δ⁹-THCB) causes highly significant weight reduction in comparison to control and acetonitrile. FIG. 5C: Larvae feeding assay on olivetol cannabinoid. It was found that none of the olivetol cannabinoids had any effect on their weight when compared to control and acetonitrile. FIG. 5D; Larvae feeding assay on phorol cannabinoid, It was found that none of the phorol cannabinoids had any effect on their weight when compared to control and acetonitrile. (n=5, P<0.05, **P<0.01, ***P<0.001, ***P<0.001).

FIG. 6 shows the effect of Δ⁹-THCVA on the growth of the larvae. The weight of the larvae was taken at 2 day intervals until the 8th day (n=5).

FIGS. 7A-7C show the effect of Δ⁹-THCVA on the growth of the larvae compared to control and acetonitrile on the 6th day of the start of experiment. FIG. 7A: The growth rate of the larvae, feeding on control feed (artificial insect diet). FIG. 7B: The growth rate of the larvae, feeding on solvent control (artificial insect diet with acetonitrile). FIG. 7C: The growth rate of the larvae, feeding on Δ⁹-THCVA treatment feed (artificial insect diet with Δ⁹-THCVA).

FIGS. 8A-8C show the effect of Δ⁹-THCVA on the growth of the larvae compared to control and acetonitrile on the 8th day of the experiment. FIG. 8A: The growth of the larvae, feeding on control feed (artificial insect diet). FIG. 8B: The growth of the larvae, feeding on solvent control (artificial insect diet with acetonitrile). FIG. 8C: The growth of the larvae, feeding on Δ⁹-THCVA treatment feed (artificial insect diet with Δ⁹-THCVA).

FIG. 9 shows the survivability percentage (larvae-adult emergence). The transformation from larva to pupa and from pupa to adult emergence was observed for the survivability test (n=5), 40% of the larvae feeding on the Δ⁹-THCVA diet only survived to form an adult beet armyworm moth (n=5, P<0.05, **P<0.01, ***P<0.001, ***P<0.001).

FIG. 10 shows the effect of Δ⁹-THCVA on the survivability of the larvae compared to control and acetonitrile. Adult beet armyworm moth emerge from the control and acetonitrile treatments while from the Δ⁹-THCVA treatment only 40% of the larvae survived to emerge as adult beet armyworm moth (n=5).

FIG. 11 shows the effect of Δ⁹-THCV on the growth of the larvae. The weight of the larvae was taken at 2 day intervals for 8 days (n=5).

FIGS. 12A-12C show the effect of Δ⁹-THCV on the growth of the larvae compared to control and acetonitrile on the 6th day of the experiment. FIG. 12A: The growth rate of the larvae, feeding on control feed (artificial insect diet). FIG. 12B: The growth rate of the larvae, feeding on solvent control (artificial insect diet with acetonitrile). FIG. 12C: The growth rate of the larvae, feeding on Δ⁹-THCV treatment feed (artificial insect diet with Δ⁹-THCV).

FIGS. 13A-13C show the effect of Δ⁹-THCV on the growth of the larvae compared to control and acetonitrile on the 8th day of the experiment. FIG. 13A: The growth of the larvae, feeding on control feed (artificial insect diet). FIG. 13B: The growth of the larvae feeding on solvent control (artificial insect diet with acetonitrile). FIG. 13C: The growth of the larvae, feeding on Δ⁹-THCV treatment feed (artificial insect diet with Δ⁹-THCV).

FIG. 14 shows the survivability (larvae-adult emergence) of larvae. The transformation from larva to pupa and from pupa to adult emergence was observed for the survivability test (n=5). Only 20% of larvae feeding on the Δ⁹-THCV feed survived to form an adult beet armyworm moth.

FIG. 15 shows the effect of Δ⁹-THCV on the survivability of the larvae compared to control and acetonitrile. Adult beet armyworm moth emerge from the control and acetonitrile treatments while from the Δ⁹-THCV treatment only 20% of the larvae survived to emerge as adult beet armyworm moth (n=5).

FIG. 16 shows the effect of Δ⁸-THCVA on the growth of the larvae. The weight of the larvae was taken at 2 day intervals for 8 days (n=5, *P<0.05, **P<0.01, ***P<0.001, ****P<0.001).

FIGS. 17A-17C show the effect of Δ⁸-THCVA on the growth of the larvae compared to control and acetonitrile on the 6th day of the experiment. FIG. 17A The growth of the larvae, feeding on control feed (artificial insect diet). FIG. 17B The growth of the larvae, feeding on solvent control (artificial insect diet with acetonitrile), FIG. 17C The growth of the larvae, feeding on Δ⁸-THCVA treatment feed (artificial insect diet with Δ⁸-THCVA).

FIGS. 18A-18C show the effect of Δ⁸-THCVA on the growth of the larvae compared to control and acetonitrile on the 8th day of the experiment. FIG. 18A. The growth of the larvae, feeding on control feed (artificial insect diet). FIG. 18B. The growth of the larvae, feeding on solvent control (artificial insect diet with acetonitrile). FIG. 18C The growth of the larvae, feeding on Δ⁸-THCVA treatment feed (artificial insect diet with Δ⁸-THCVA).

FIG. 19 shows the survivability (larvae-adult emergence) of larvae. The transformation from larva to pupa and from pupa to adult emergence was observed for the survivability test. None of the larvae on the Δ⁸-THCVA feed survived to form an adult beet armyworm moth. (n=5, “P<0.05, **P<0.01, ***P<0.001, ****P<0.001).

FIG. 20 shows the effect of Δ⁸-THCVA on the survivability of the larvae compared to control and acetonitrile. All the larvae from control and acetonitrile treatments emerged as adult beet armyworm moths, while none of the larvae from the Δ⁸-THCVA treatment survived to emerge as adult beet armyworm moth (n=5).

FIG. 21 shows the effect of Δ⁸-THCV on the growth of the larvae. The weights of the larvae were taken at interval of every 2 days for 8 days. (n=5, P<0.05, **p<0.01, ***P<0.001, ***P<0.001).

FIGS. 22A-22C show the effect of Δ⁸-THCV on the growth of the larvae compared to control and acetonitrile on the 6th day of the experiment. FIG. 22A: The growth of the larvae, feeding on control feed (artificial insect diet). FIG. 22B: The growth of the larvae, feeding on solvent control (artificial insect diet with acetonitrile). FIG. 22C: The growth of the larvae, feeding on Δ⁸-THCV treatment feed (artificial insect diet with Δ⁸-THCV).

FIGS. 23A-23C show the effect of Δ⁸-THCV on the growth of the larvae compared to control and acetonitrile on the 8th day of the experiment. FIG. 23A. The growth of the larvae, feeding on control feed (artificial insect diet). FIG. 23B: The growth of the larvae, feeding on solvent control (artificial insect diet with acetonitrile). FIG. 23C The growth of the larvae, feeding on Δ⁸-THCV treatment feed (artificial insect diet with Δ⁸-THCV).

FIG. 24 shows the survivability (larvae-adult emergence) of larvae. The transformation from larva to pupa and from pupa to adult emergence was observed for the survivability test. Only 20% of larvae feeding on the Δ⁸-THCV feed survived to form an adult beet armyworm moth. (n=5, P<0.05, **P<0.01, ***P<0.001, ***P<0.001).

FIG. 25 shows the effect of Δ⁸-THCV on the survivability of the larvae compared to control and acetonitrile. All the larvae from control and acetonitrile emerged as adult beet armyworm moths while only 20% of larvae from the Δ⁸-THCV treatment survived to emerge as adult beet armyworm moth (n=5).

FIG. 26 shows the effect of Δ⁹-THCB on the growth of the larvae. The weight of the larvae was taken at intervals of every 2 days for a total of 8 days. (n=5, P<0.05, **P<0.01, ***P<0.001, ****P<0.001).

FIGS. 27A-27C show the effect of Δ⁹-THCB on the growth of the larvae compared to control and acetonitrile on the 6th day of the start of experiment. FIG. 27A The growth of the larvae, feeding on control feed (artificial insect diet). FIG. 27B The growth of the larvae, feeding on solvent control (artificial insect diet with acetonitrile). FIG. 27C The growth of the larvae, feeding on Δ⁹-THCB treatment feed (artificial insect diet with Δ⁹-THCB).

FIGS. 28A-28C show the effect of Δ⁹-THCB on the growth of the larvae compared to control and acetonitrile on the 8th day of the experiment. FIG. 28A The growth of the larvae, feeding on control feed (artificial insect diet). FIG. 28B. The growth of the larvae, feeding on solvent control (artificial insect diet with acetonitrile). FIG. 28C. The growth of the larvae, feeding on Δ⁹-THCB treatment feed (artificial insect diet with Δ⁹-THCB)

FIG. 29 shows the survivability (larvae-adult emergence) of larvae. The transformation from larva to pupa and from pupa to adult emergence was observed for the survivability test. None of the larvae on the Δ⁹-THCB feed survived to form an adult beet armyworm moth (n=5, *P<0.05, **P<0.01, ***P<0.001, ****P<0.001).

FIG. 30 shows the effect of Δ⁹-THCB on the survivability of the larvae compared to control and acetonitrile. All the larvae from control and acetonitrile treatments emerged as adult beet armyworm moths, while none of the larvae from the Δ⁹-THCB treatment survived to emerge as adult beet armyworm moth (n=5).

FIGS. 31A-31C show olivetol cannabinoids quantification in both the control and larvae herbivory treatment. (FIG. 31A) Larvae herbivory experiment, picture of the control and larvae fed (treatment) plant on the fourth day of start of experiment. (FIG. 31B) Beet armyworm larvae feeding on the leaves of the cannabis plant. (FIG. 31C) Olivetol cannabinoids quantification in the flower bud of control and larvae herbivory treatment (nd=not detected, n=3, *P<0.05, **P<0.01, ***P<0.001, ****P<0.0001)

FIGS. 32A-32C show minor cannabinoids (Varinol, Butol, Phorol) quantification in both the control and larvae herbivory treatment. (FIG. 32A) Varinol cannabinoid quantification in the flower bud of control and larvae herbivory treatments. (FIG. 32B) Butol cannabinoid quantification in the flower bud of control and larvae herbivory. (FIG. 32C) Phorol cannabinoid quantification in the flower bud of control and larvae herbivory. nd=not detected (n=3, *P<0.05, **P<0.01, ***P<0.001, ****P<0.0001).

FIG. 33A shows hierarchical clustering and FIG. 33B shows principal component analysis (2D) score plot demonstrating statistical clustering of transcript in response to larvae herbivory and control. FIG. 33C shows a volcano plot showing log 2-fold changes (FC) of differentially expressed genes with FDR on y-axis and fold change on x-axis, (FDR (0.05) and FC (1.3)). FIG. 33D shows a heat map of the top 45 transcript showing contrasting abundance between the control and the larvae treatment.

FIGS. 34A-34B show gene functional and pathway enrichment analysis of the upregulated DEG in response to larvae herbivory. (FIG. 34A) Gene ontology of upregulated DEG in terms of biological process, cell component, and molecular function. (FIG. 34B) KEGG pathway enrichment analysis of upregulated with enriched pathway on y-axis, fold enrichment on x-axis and size of the bubble demonstrate the number of genes upregulated in the given pathway.

FIGS. 35A-35B show visualization of metabolite flux and crosstalk between different pathways in response to insect herbivory. (FIG. 35A) Heat map of the transcriptomics profile of enzymes involved in cannabinoid, terpene, fatty acid, jasmonic acid and membrane lipid degradation pathway. (FIG. 35B) Diagram demonstrating metabolite flow and cross talk between cannabinoid, terpenoid, fatty acid, jasmonic acid and membrane lipid degradation pathway with their respective enzymes. The enzymes name and the arrow represent upregulation, downregulation or no change in response to the larvae herbivory (n=3, *P<0.05, **P<0.01, ***P<0.001, ****P<0.0001).

FIGS. 36A-36B show cannabinoid quantification from chemical biotic stress inducer experiments. (FIG. 36A) Cannabinoid quantification in the flower bud of control and methyl jasmonate treatments. (FIG. 36B) Cannabinoid quantification in the flower bud of control and methyl salicylate treatments. (n=3, *P<0.05, **P<0.01, ***P<0.001, ****P<0.0001, ns=nonsignificant).

FIG. 37 shows gene ontology of downregulated DEG in terms of biological process, cell component, and molecular function.

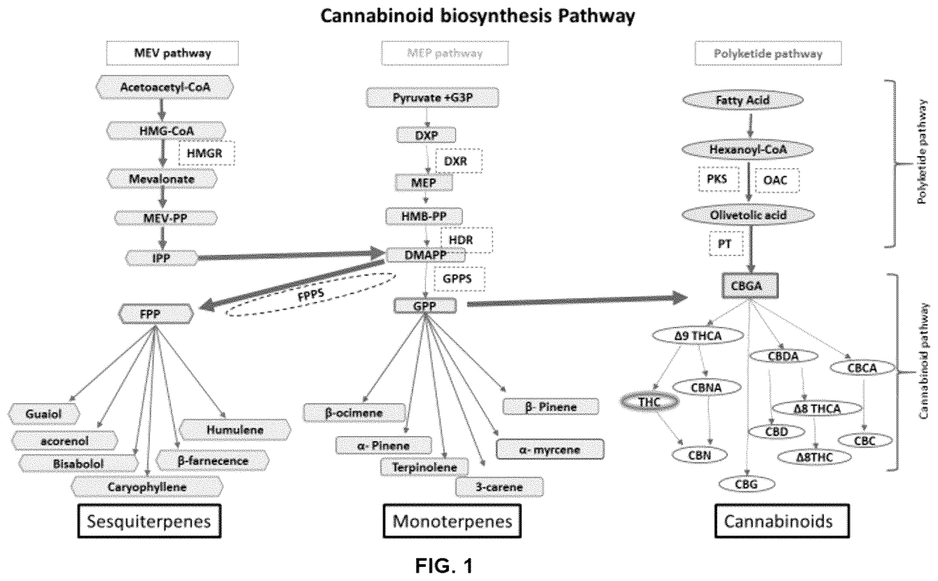

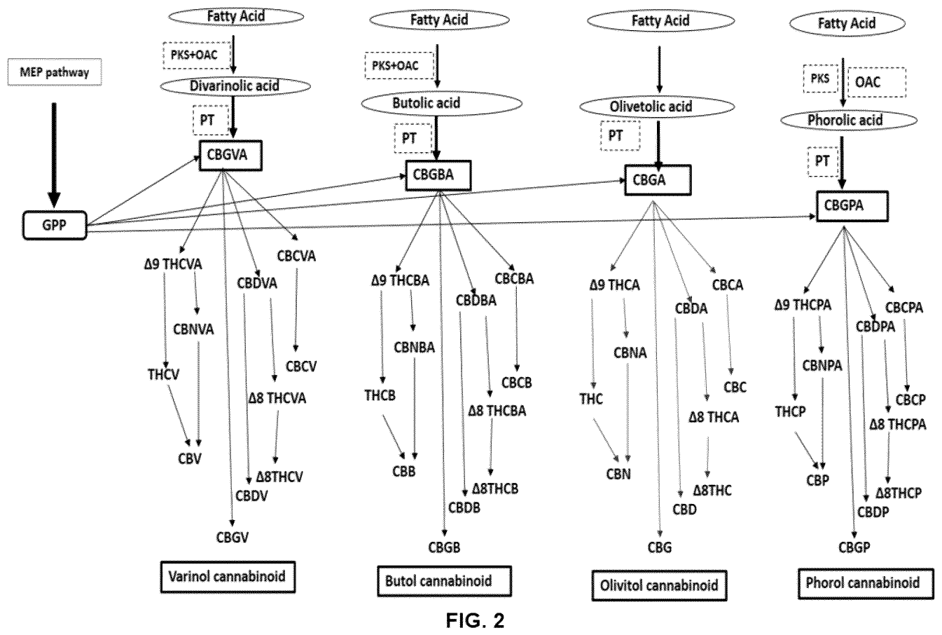

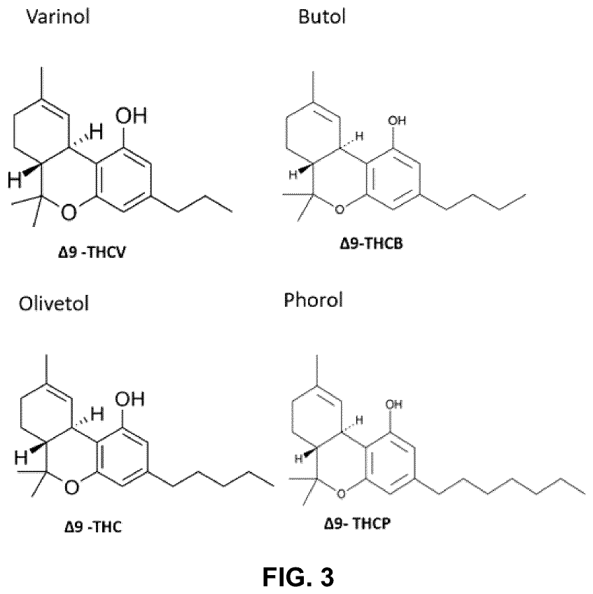

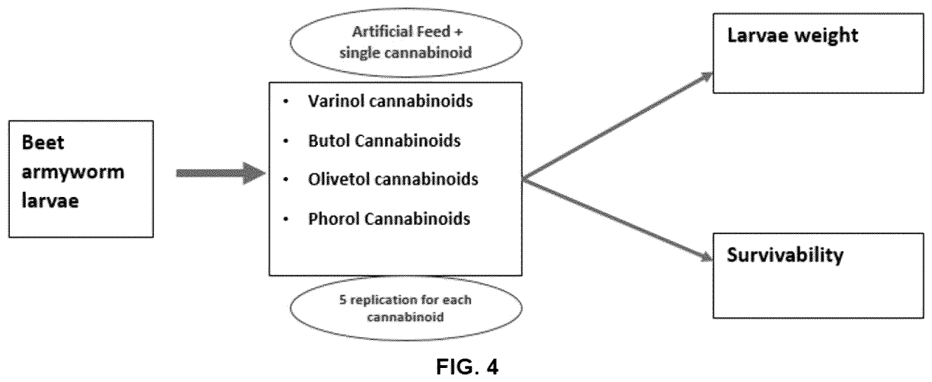

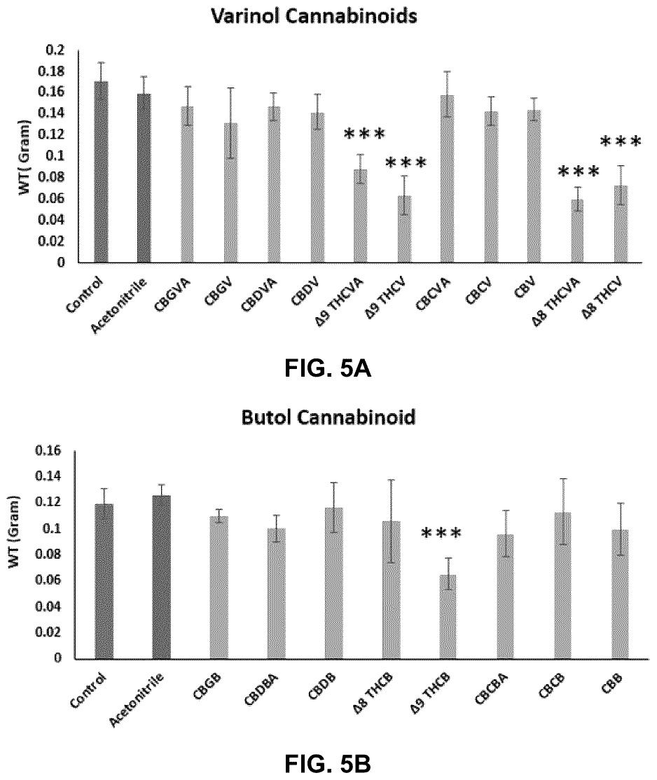

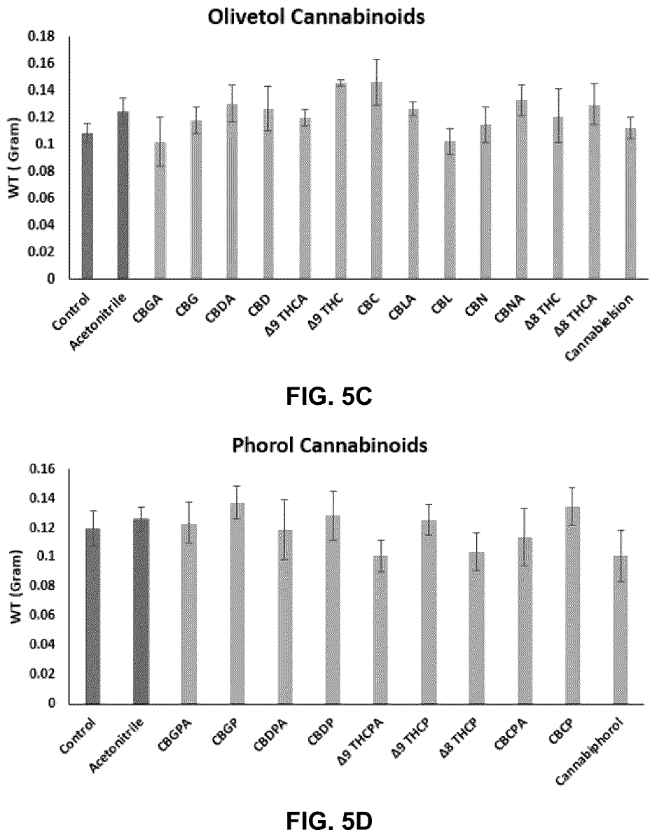

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Disclosed herein is use of a set of cannabinoids, natural chemical compounds synthesized in Cannabis plants, as insecticides. Also disclosed herein are insecticide compositions including the disclosed cannabinoids. In one aspect, these cannabinoids are naturally produced, easily biodegraded, and have no recorded adverse effect on human health.

Although several studies claim that cannabis extracts or CBD oil have some sort of insecticidal properties, the cannabis extracts and CBD oils used by these studies represents a blend of more than 100 different major and minor cannabinoids present in varying concentrations. These previous studies claim the observed insecticidal properties are primarily associated with CBD and/or THC as these are the two major cannabinoids that are abundant in the tested cannabis extracts and CBD oil. However, insecticidal activity of the minor cannabinoids present in these cannabis extracts and CBD has not been tested previously. In one aspect, minor cannabinoids have herein been assessed for insecticidal activity.

### Pesticide Compositions

In one aspect, disclosed herein is a pesticide composition including a minor cannabinoid and at least one excipient, diluent, surfactant, or carrier. In a further aspect, the minor cannabinoid can be or include 49-tetrahydrocannabivarinic acid (Δ⁹-THCVA), Δ⁹-tetrahydrocannabivarin (Δ⁹-THCV), Δ⁸-tetrahydrocannabivarinic acid (Δ⁸-THCVA), Δ⁸-tetrahydrocannabivarin (Δ⁸-THCV), Δ⁹-tetrahydrocannabutol (Δ⁹-THCB), or any combination thereof, including pesticide compositions with two or more, three or more, four or more, or all five of these minor cannabinoids. In an aspect, other minor cannabinoids are also contemplated for use in the compositions and should be considered disclosed.

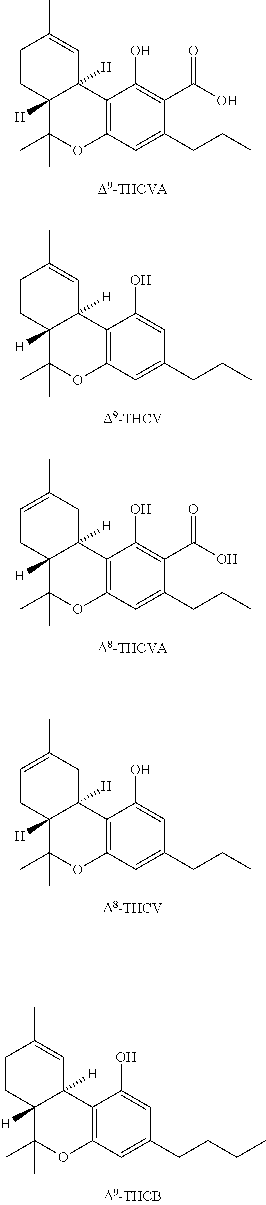 [SMILES: CCCc1cc2c(c(O)c1C(=O)O)[C@@H]1C=C(C)CC[C@H]1C(C)(C)O2 ; CCCc1cc(O)c2c(c1)OC(C)(C)[C@@H]1CCC(C)=C[C@@H]21 ; CCCc1cc2c(c(O)c1C(=O)O)[C@@H]1CC(C)=CC[C@H]1C(C)(C)O2 ; CCCc1cc(O)c2c(c1)OC(C)(C)[C@@H]1CC=C(C)C[C@@H]21 ; CCCCc1cc(O)c2c(c1)OC(C)(C)[C@@H]1CCC(C)=C[C@@H]21]

In another aspect, in the disclosed pesticide composition, the at least one excipient, diluent, surfactant, or carrier confers increased stability, wettability, dispersibility, or adherence to a substrate relative to an otherwise equivalent composition lacking the carrier. In a still further aspect, the composition can be formulated as an emulsion, a colloid, a granule, a pellet, a powder, a spray, a suspension, or a solution. In another aspect, the at least one excipient, diluent, surfactant, or carrier can be a solvent, an emulsifier, a buffer, a cryoprotectant, a salt, microbial culture medium, a wetting agent, a bulking agent, an anti-caking agent, a thickener, a clay, a mineral, a lipid, a gum, a dye or colorant, a biological waste material, or any combination thereof.

In some aspects, the disclosed compositions further include an effective amount of at least one additional active ingredient such as, for example, a fertilizer, a pesticide, an herbicide, or any combination thereof. In another aspect, when the additional active ingredient is a pesticide, the pesticide can be an organic or natural pesticide selected from the group consisting of neem oil, nicotine, a bacillus-based insecticide, or pyrethrin. However, synthetic pesticides are also contemplated and should be considered disclosed.

### Methods of Using the Compositions

In an aspect, disclosed herein is a method for reducing damage caused by an insect pest to a plant, the method including at least the step of applying a disclosed pesticide composition to the plant or to at least one environmental component of the plant. In another aspect, the plant can be an ornamental plant, a food crop, an energy crop, a fiber crop, a timber crop, or a combination thereof (e.g. a corn plant is a food crop but also may be considered as an energy crop if corn-derived ethanol is produced from the same).

In an aspect, the food crop can be selected from a horticultural crop including but not limited to asparagus, bean, red garden beet, broccoli, cabbage, cauliflower, celery, chickpea, corn, cowpea, eggplant, lettuce, onion, pea, pepper, potato, radish, spinach, sweet potato, tomato, rice, sorghum, sugarcane, wheat, cotton, soybeans, barley, rye, oats, peanuts, sugar beets, grapes, alfalfa, turnip, or any combination thereof. In some non-limiting aspects, the insect pest can be beet armyworm, although the disclosed compositions can also work on other insects and their larvae including, but not limited to, fall armyworms, African armyworm, true armyworm, yellow striped armyworms, southern armyworm, western yellow striped armyworms, grasshoppers, cabbage looper, tomato hornworms, diamondback moth, Japanese beetles, flea beetles, Colorado potato beetles, Mexican bean beetles, cucumber beetles, house flies, and combinations thereof.

In another aspect, the composition can be applied before exposure to the insect pest or after exposure to the insect pest. In another aspect, the at least one environmental component can be or include leaf debris, soil, a rhizosphere of the plant, or any combination thereof. In still another aspect, the composition can be applied to one or more roots, leaves, fruits, flowers, stems, or seeds of the plant, or any combination thereof. In one aspect, the composition can be applied to soil, compost, mulch, leaf litter, sawdust, straw, pine straw, wood chips, gravel, plant growing medium, or other material in a bed surrounding the plant.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a minor cannabinoid,” “a carrier,” or “a pest,” includes, but is not limited to, mixtures or combinations of two or more such minor cannabinoids, carriers, or pests, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a minor cannabinoid refers to an amount that is sufficient to achieve the desired improvement in the property modulated by the formulation component, e.g. achieving the desired level of control of a target pest. The specific level in terms of wt % in a composition required as an effective amount will depend upon a variety of factors including the specific identity of the minor cannabinoid, the presence of other minor cannabinoids or insecticides in a formula, amount and type of carrier, number and frequency of applications of the formulation, and identity of the plant to which it is applied.

As used herein, the terms “optional” or “optionally” means that the subsequently described event or circumstance can or cannot occur, and that the description includes instances where said event or circumstance occurs and instances where it does not.

### Cannabinoids

Cannabinoid pathway: Cannabinoids are the terpenophenolic compounds synthesized in the glandular trichome of cannabis. The first cannabinoid molecule CBGA is synthesized by the condensation of GPP from the MEP pathway with the olivetolic acid from the polyketide pathway by the prenyl transferase enzyme (PT). From CBGA many acidic and neutral forms of cannabinoids are synthesized enzymatically and non-enzymatically.

Cannabinoids: More than 150 cannabinoids have been identified in cannabis and these are categorized into four groups based on their alkyl chain length. These are varinol cannabinoids with three-carbon alkyl chains, butol cannabinoids with four-carbon alkyl chains, olivetol cannabinoids with five-carbon alkyl chains, and phorol cannabinoids with seven-carbon alkyl chains. These 4 cannabinoids are further grouped into major and minor cannabinoids depending on their abundance. Olivetol cannabinoids are classified as major cannabinoids as most of the present-day cannabis strains are dominant in olivetol cannabinoids. On the other hand, varinol, butol, and phorol cannabinoids are classified as minor cannabinoids as most of the present-day cannabis strains only synthesize these cannabinoids in trace amounts.

### Major Cannabinoids

Major cannabinoids are cannabinoid compounds that are abundant in many strains and/or cultivars of cannabis. Major cannabinoids typically include, but are not limited to, THC, CBD, cannabigerol (CBG), and the like.

Olivetol Cannabinoids: The olivetol cannabinoids are classified as the major cannabinoids. Most of the strains of cannabis available today are dominant in olivetol cannabinoids. Here, the olivetolic acid is synthesized with the condensation of hexanoyl-CoA with three malonyl-CoA. The polyketide synthase (PKS III) and olivetol acid cyclase (OAC) are responsible for the condensation. Olivetolic cannabinoids have five carbon alkyl chains. From the olivetolic acid CBGA (cannabigerolic acid) is synthesized with the help of the prenyl transferase (PT-4) enzyme which is the first precursor molecule for the downstream synthesis of olivetol cannabinoids.

### Minor Cannabinoids

Minor cannabinoids are compounds that are not as plentiful as major cannabinoids and that may not be present in all cultivars and/or strains and include, but are not limited to, tetrahydrocannabivarin (THCV), tetrahydrocannabibutol (THCB), tetrahydrocannabiphorol (THCP), and the like. Other important minor cannabinoids are discussed in detail below.

Varinol cannabinoids: Varinol cannabinoids fall under minor cannabinoids as they are synthesized in trace amounts in most of the present-day cannabis strains. Here, the divarinolic acid is synthesized by the condensation of butanoyl-CoA with three malonyl-CoA. The ployketide synthase and unknown acid cyclase are responsible for the condensation. Varinol cannabinoids have three carbon alkyl chains. From the divarinolic acid CBGVA (cannabigerovarinic acid) is synthesized with the help of the prenyl transferase (PT-4) enzyme which is the first precursor molecule for the synthesis of downstream varinol cannabinoids. Δ⁹-THCV has only half the binding affinity against CB1 compared to Δ⁹-THC.

Butol cannabinoids: Butol cannabinoids fall under minor cannabinoids as they are synthesized in trace amounts in most of the present-day cannabis strains. Here, the butolic acid is synthesized by the condensation of pentanoyl-CoA with three malonyl-CoA. The polyketide synthase (PKS) and unknown acid cyclase are responsible for the condensation. Butol cannabinoids have four carbon alkyl chains. From the butolic acid CBGBA (cannabigerobutolic acid) is synthesized with the help of the prenyl transferase (PT-4) enzyme which is the first precursor molecule for the synthesis of downstream butol cannabinoids. Δ⁹-THCB has a 3-time higher binding affinity against CB1 compared to Δ⁹-THC.

Phorol cannabinoids: Phorol cannabinoids fall under minor cannabinoids as they are synthesized in extremely low trace amounts in most present-day cannabis strains. Here, the phorolic acid is synthesized by the condensation of octanoyl-CoA with three malonyl-CoA. The polyketide synthase (PKS) and unknown acid cyclase are responsible for the condensation. Phorol cannabinoids have seven carbon alkyl chains. From phorolic acid, CBGPA (cannabigerophorolic acid) is synthesized with the help of the prenyl transferase (PT-4) enzyme which is the first precursor molecule for the synthesis of downstream phorol cannabinoids. Δ⁹-THCP has a 33-time higher binding affinity against CB1 compared to Δ⁹-THC.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Aspects

The present disclosure can be described in accordance with the following numbered aspects, which should not be confused with the claims.

Aspect 1. A pesticide composition comprising a minor cannabinoid and at least one excipient, diluent, surfactant, or carrier.

Aspect 2. The pesticide composition of aspect 1, wherein the minor cannabinoid comprises 49-tetrahydrocannabivarinic acid (Δ⁹-THCVA), Δ⁹-tetrahydrocannabivarin (Δ⁹-THCV), Δ⁸-tetrahydrocannabivarinic acid (Δ⁸-THCVA), Δ⁸-tetrahydrocannabivarin (Δ⁸-THCV), Δ⁹-tetrahydrocannabutol (Δ⁹-THCB), or any combination thereof.

Aspect 3. The pesticide composition of aspect 2, wherein the minor cannabinoid is Δ⁹-THCVA.

Aspect 4. The pesticide composition of aspect 2, wherein the minor cannabinoid is Δ⁹-THCV.

Aspect 5. The pesticide composition of aspect 2, wherein the minor cannabinoid is Δ⁸-THCVA.

Aspect 6. The pesticide composition of aspect 2, wherein the minor cannabinoid is Δ⁸-THCV.

Aspect 7. The pesticide composition of aspect 2, wherein the minor cannabinoid is Δ⁹-THCB.

Aspect 8. The pesticide composition of aspect 2, wherein the minor cannabinoid comprises two or more of Δ⁹-THCVA, Δ⁹-THCV, Δ⁸-THCVA, Δ⁸-THCV, and Δ⁹-THCB.

Aspect 9. The pesticide composition of any one of aspects 1-8, wherein the at least one excipient, diluent, surfactant, or carrier confers increased stability, wettability, dispersibility, or adherence to a substrate relative to a composition lacking the carrier.

Aspect 10. The pesticide composition of any one of aspects 1-9, wherein the composition comprises an emulsion, a colloid, a granule, a pellet, a powder, a spray, a suspension, or a solution.

Aspect 11. The pesticide composition of any one of aspects 1-10, wherein the at least one excipient, diluent, surfactant, or carrier comprises a solvent, an emulsifier, a buffer, a cryoprotectant, a salt, microbial culture medium, a wetting agent, a bulking agent, an anti-caking agent, a thickener, a clay, a mineral, a lipid, a gum, a dye or colorant, a biological waste material, or any combination thereof.

Aspect 12. The pesticide composition of any one of aspects 1-11, wherein the composition further comprises an effective amount of at least one additional active ingredient.

Aspect 13. The pesticide composition of aspect 12, wherein the additional active ingredient comprises a fertilizer, a pesticide, an herbicide, or any combination thereof.

Aspect 14. The pesticide composition of aspect 13, wherein the additional active ingredient is a pesticide selected from the group consisting of neem oil, nicotine, a bacillus-based insecticide, pyrethrin, or a synthetic insecticide.

Aspect 15. A method for reducing damage caused by an insect pest to a plant, the method comprising applying the pesticide composition of any one of aspects 1-14 to the plant or to at least one environmental component of the plant.

Aspect 16. The method of aspect 15, wherein the plant comprises an ornamental plant, a food plant, an energy crop, a fiber crop, a timber crop, or a combination thereof.

Aspect 17. The method of aspect 16, wherein the food plant comprises asparagus, bean, red garden beet, broccoli, cabbage, cauliflower, celery, chickpea, corn, cowpea, eggplant, lettuce, onion, pea, pepper, potato, radish, spinach, sweet potato, tomato, rice, sorghum, sugarcane, wheat, cotton, soybeans, barley, rye, oats, peanuts, sugar beets, grapes, alfalfa, turnip, or any combination thereof.

Aspect 18. The method of any one of aspects 15-17, wherein the insect pest comprises beet armyworm, fall armyworms, African armyworm, true armyworm, yellow striped armyworms, southern armyworm, western yellow striped armyworms, grasshoppers, cabbage looper, tomato hornworms, diamondback moth, Japanese beetles, flea beetles, Colorado potato beetles, Mexican bean beetles, cucumber beetles, house flies, or any combination thereof.

Aspect 19. The method of any one of aspects 15-18, wherein the composition is applied before exposure to the insect pest.

Aspect 20. The method of any one of aspects 15-18, wherein the composition is applied after exposure to the insect pest.

Aspect 21. The method of any one of aspects 15-20, wherein the at least one environmental component comprises leaf debris, soil, a rhizosphere of the plant, or any combination thereof.

Aspect 22. The method of any one of aspects 15-21, wherein the composition is applied to one or more roots, leaves, fruits, flowers, stems, or seeds of the plant, or any combination thereof.

Aspect 23. The method of any one of aspects 15-22, wherein the composition is applied to soil, compost, mulch, leaf litter, sawdust, straw, pine straw, wood chips, gravel, plant growing medium, or other material in a bed surrounding the plant.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Materials and Methods

Beet armyworm larvae: First instar beet armyworm larvae were purchased from Benzon Research Inc. (Carlisle, PA). The larvae were raised by feeding them on artificial diet until they are second instar (approximately 0.5 cm long). These second instar larvae were used at the start of each experiment.

Insect diet preparation: The insect artificial diet was purchased from Benzon Research Inc. (Carlisle, PA). To prepare the semi-solid feed, the powered diet was mixed with boiling water and kept for a few minutes to solidify. The cooled diet was cut into rectangular cubes of 1 cm in length, 0.5 cm in width, and 0.5 cm in height. The pure cannabinoids were dissolved in acetonitrile and spread on the surface of this cube with a 5 μL pipet. Each cannabinoid treatment had 5 replications. The control was artificial diet only and the solvent control was the artificial diet with acetonitrile applied to the surface of the cube to exclude any potential effect by the solvent.

Minor cannabinoid treatment: All the available pure minor cannabinoids from the varinol series, butol series, and phorol series were purchased from Cayman Chemical Company (Ann Arbor, MI). 1 mg of each chemical has been purchased either as solid or dissolved in acetonitrile or methanol. For each treatment, the cannabinoid concentration in the artificial diet was 0.01% w/w. Each diet cube was kept in a Petri dish with one larva in it and was sealed with parafilm.

Data collection: Two types of measurements were taken throughout the experiment. Data were collected for the weight of larvae and survival rate. The initial weight of larvae, before the start of the experiment was recorded. At 48-hour intervals, the weight of the larvae was taken, the pupation date from the beginning of the experiment were calculated, and the survival rate and the total life cycle were calculated from adult to adult.

Statistical analysis: Statistical analysis of collected data was done using the graph pad Prism statistical software. The one-way repeated measure ANOVA has been applied to measure the difference between the control and the treatment groups.

### Example 2: Beet Armyworm Feeding Assay for Varinol, Butol, Olivetol, and Phorol Cannabinoids

The feeding assay for varinol, olivetol, and phorol was started together on one day and for butol, it was started a day later. The whole assay was divided into 2 sets: varinol, olivetol, phorol as a one set, and butol as another, and each set had its own control and acetonitrile (solvent control). It was found that in the varinol cannabinoid feeding assay, larvae feeding on some of the cannabinoids have a reduced growth rate. These are Δ⁹-THCVA, Δ⁸-THCVA, Δ⁹-THCV, and Δ⁸-THCV. Here, the larvae have significantly reduced weight when compared to larvae feeding on the control feed and the acetonitrile (solvent control) feed. Similarly, in the butol cannabinoid feeding assays, larvae were found feeding on the Δ⁹-THCB having reduced weight compared to the control and the acetonitrile. In the olivetol feeding assay, it was found that none of the olivetol cannabinoids had any effect on the weight of the larvae when compared to larvae feeding on the control feed and the acetonitrile (solvent control) feed. In the same way, in the phorol feeding assay, it was found that none of the phorol cannabinoids had any effect on the weight of the larvae when compared to larvae feeding on the control feed and the acetonitrile (solvent control) feed. So, from these 4 sets of experiments, 44 cannabinoids were tested against beet armyworm larvae and came to know that 4 varinol cannabinoids and 1 butol cannabinoid have some sort of insecticidal properties. Herein are presented the detailed results from these 5 cannabinoids (Δ⁹-THCVA, Δ⁹-THCV, Δ⁸-THCVA, Δ⁸-THCV, and Δ⁹-THCB).

### Δ⁹-THCVA

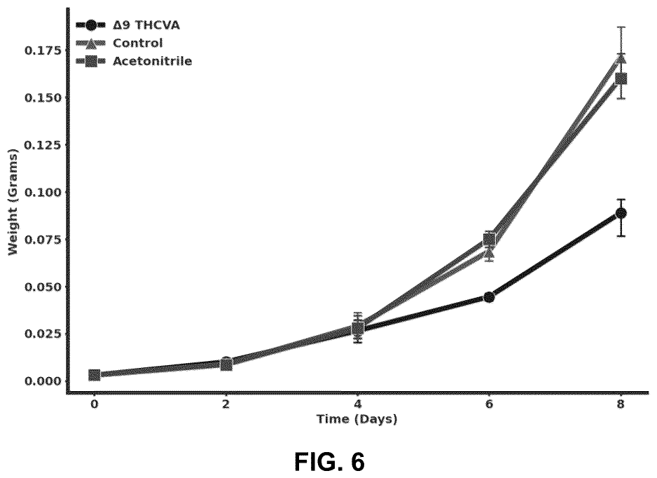

Growth of the larvae: The growth of larvae feeding on Δ⁹-THCVA was observed until the 8th day of the experiment. The weight of the same larvae was taken at an interval of 2 days for the weight comparison between the control feed and the Δ⁹-THCVA mixed feed. The result shows that there was no significant weight difference between the control and Δ⁹-THCVA until 4th day but after the 4th day larvae feeding on the Δ⁹-THCVA had a reduced weight. On the 6th and 8th days, there is a highly significant difference between the controls and the treatment FIG. 6.

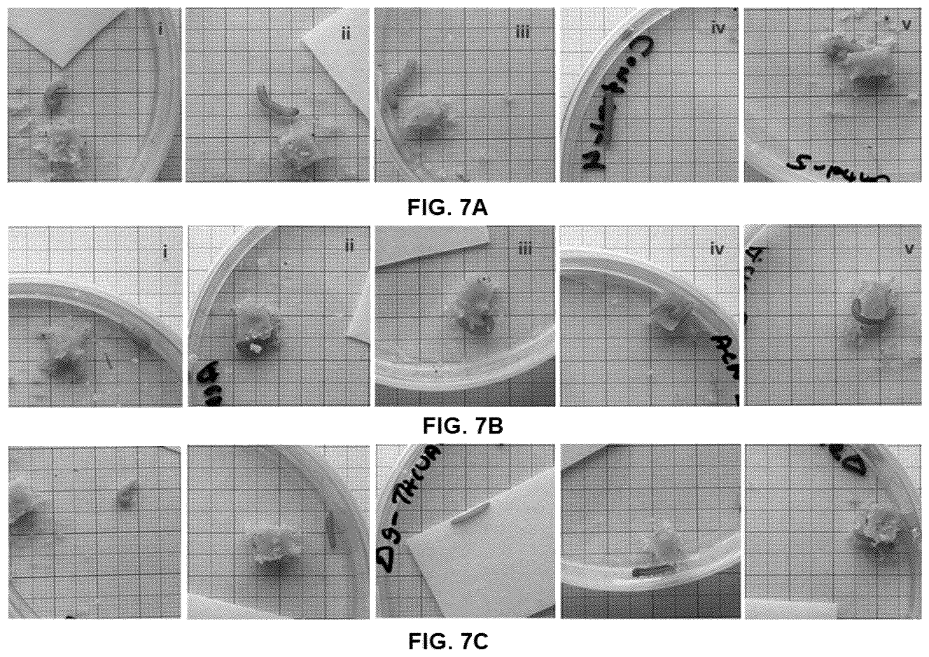

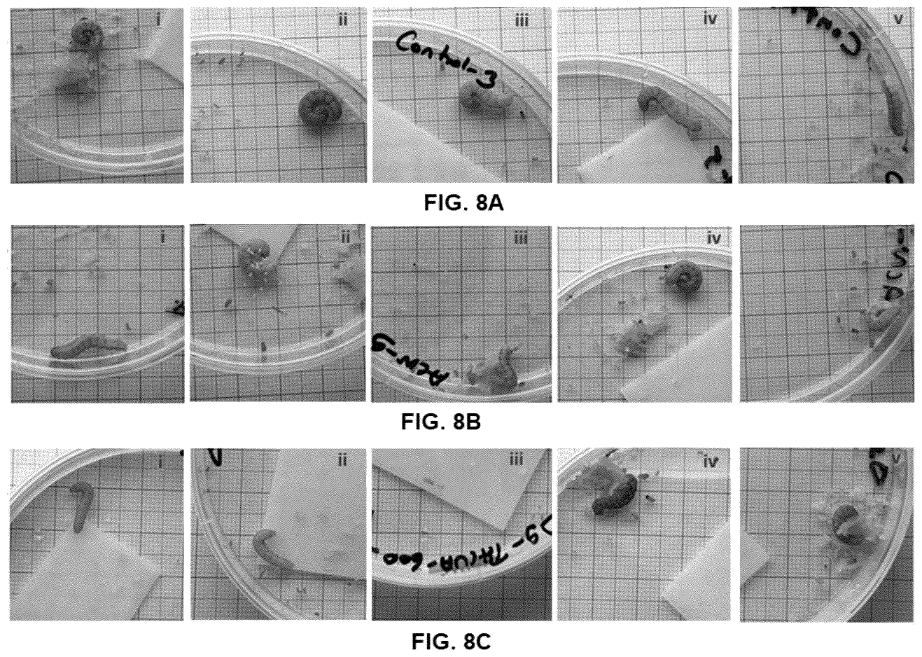

FIGS. 7A-7C demonstrate the visual difference in the size of larvae feeding on Δ⁹-THCVA compared to control on the 6th of the experiment. FIGS. 8A-8C also demonstrate the visual difference in the size of larvae feeding on Δ⁹-THCVA compared to control on the 8th day.

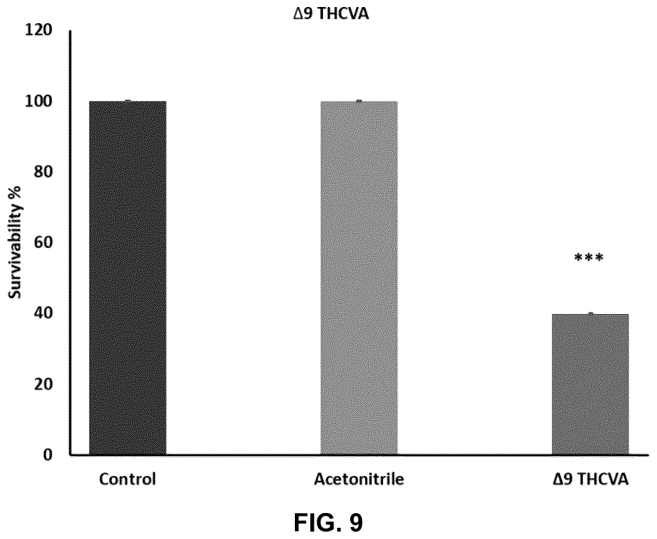

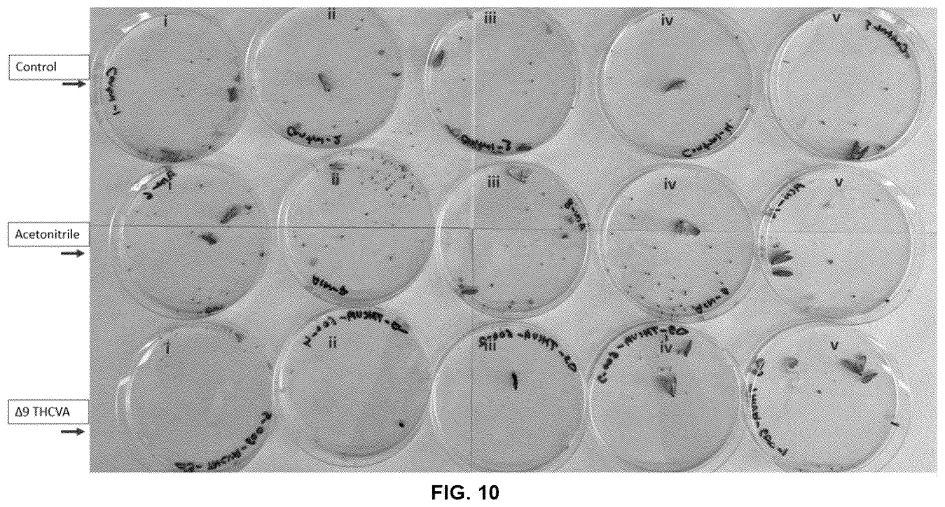

Survivability. Here, the survivability percentage of the larvae from the controls and the Δ⁹-THCVA treatment was calculated (FIG. 9). The successful emergence of larvae into an adult moth is counted as survival. It was found that 100% of the larvae from the control and acetonitrile treatment emerged into adult moths while only 40% of the larvae from the Δ⁹-THCVA treatment emerged as an adult moth (FIG. 10).

### Δ⁹-THCV

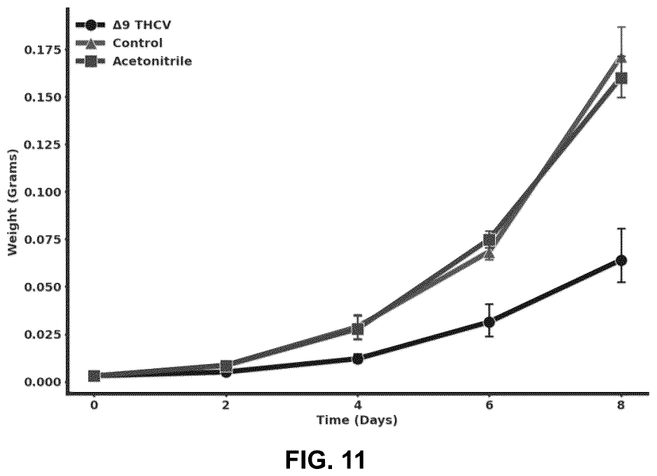

Growth of the larvae: The growth of larvae feeding on Δ⁹-THCV was observed until the 8th day of the experiment. The weight of the same larva was taken at an interval of 2 days for the weight comparison between the control feed and the Δ⁹-THCV mixed feed. The result shows no significant difference in weight between the control and Δ⁹-THCV on the 2nd day but on the 4th day and onwards larvae feeding on the Δ⁹-THCV had a reduced weight. On the 4th, 6th, and 8th days, there is a highly significant difference in the weight of larvae feeding on controls and the treatment (FIG. 11).

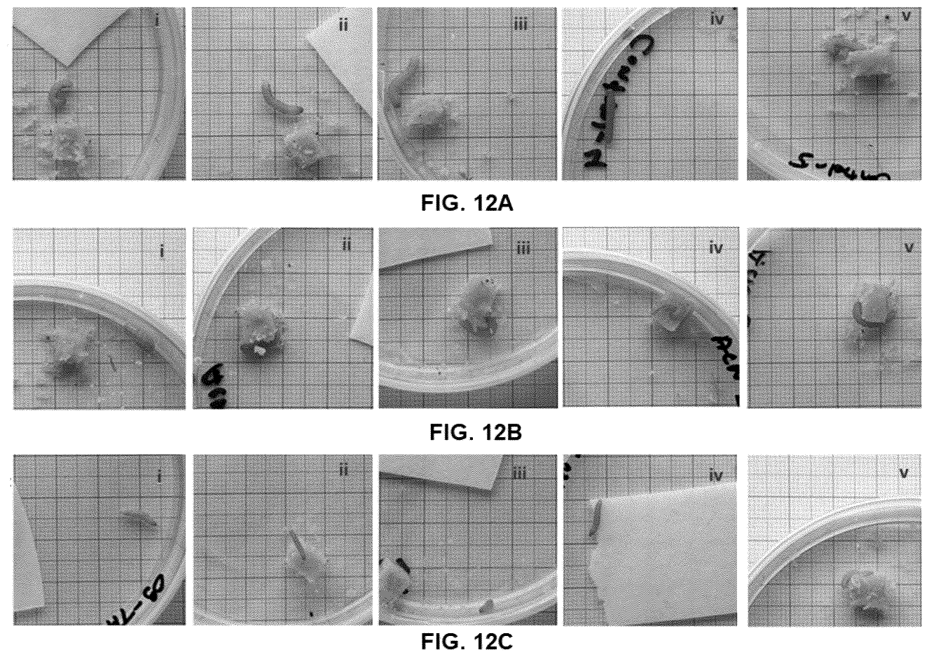

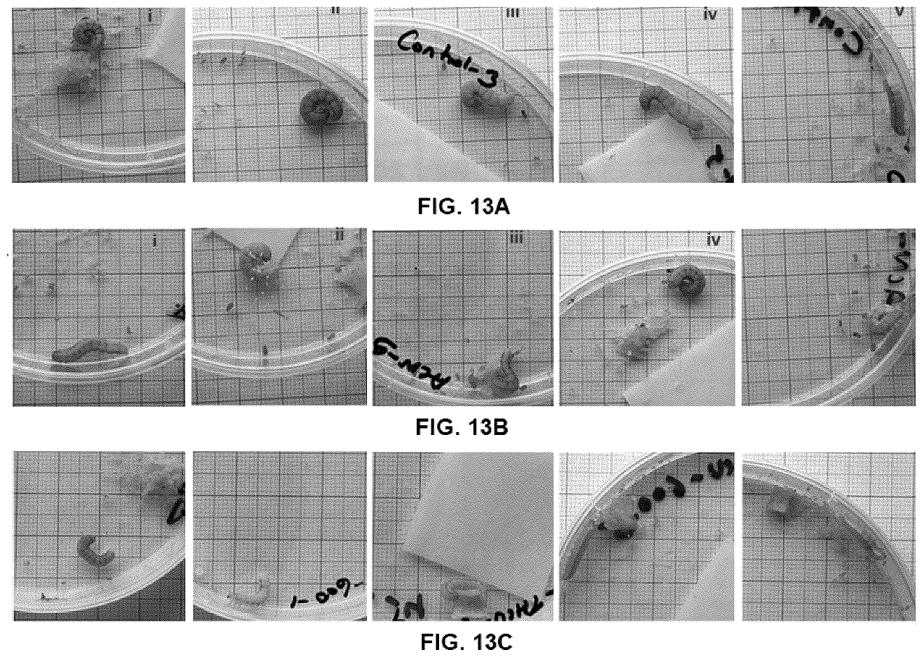

FIGS. 12A-12C demonstrate the visual difference in the size of larvae feeding on Δ⁹-THCV compared to controls on the 6th day of the experiment. FIGS. 13A-13C also demonstrate the visual difference in the size of larvae feeding on Δ⁹-THCV compared to controls on the 8th day.

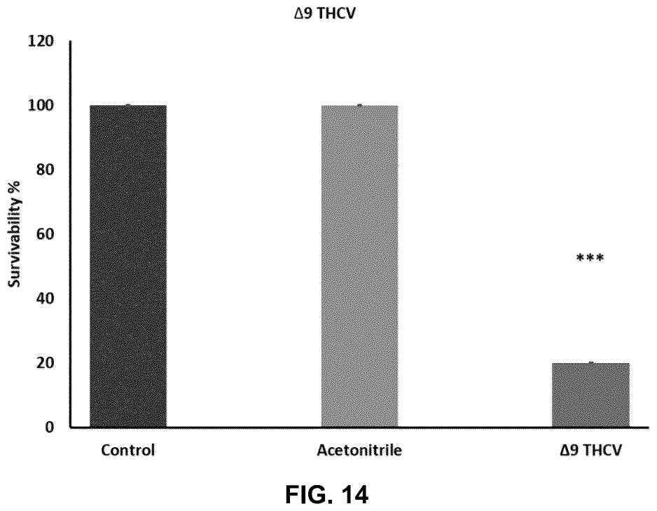

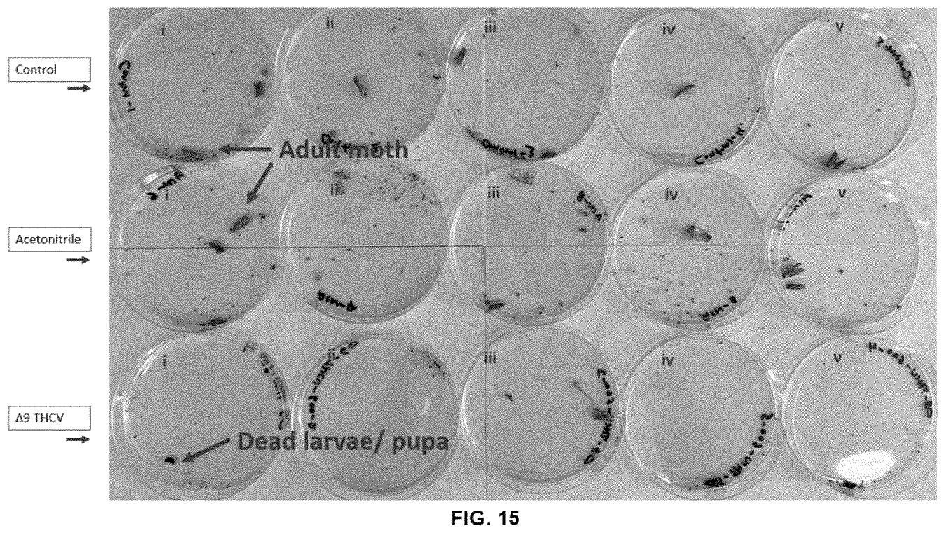

Survivability. Here, the survivability percentage of the larvae from the controls and the Δ⁹-THCV treatment was calculated (FIG. 14). The successful emergence of a larva into an adult moth is counted as survival. It was found that 100% of the larvae from the control and acetonitrile treatment emerged into adult moths while only 20% of the larvae from the Δ⁹-THCV treatment emerged as adult moths (FIG. 15).

### Δ⁸-THCVA

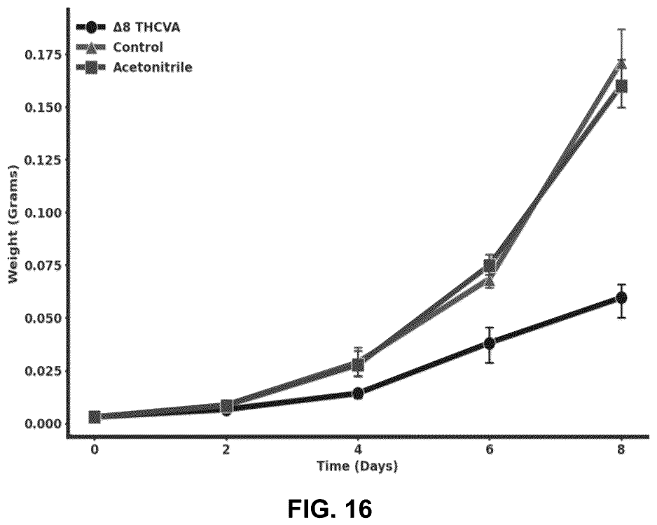

Growth of the larvae: The growth of larvae feeding on Δ⁸-THCVA was observed until the 8th day of the experiment. The weight of the same larva was taken at 2 day intervals for the weight comparison between the control feed and the Δ⁸-THCVA mixed feed. The result shows no significant difference in weight between the control and Δ⁹-THCVA on the 2nd day but on the 4th day and onwards larvae feeding on the Δ⁸-THCVA had a significantly reduced weight. On the 4th, 6th, and 8th day, there was a highly significant difference in the weight of larvae feeding on controls and the treatment (FIG. 16).

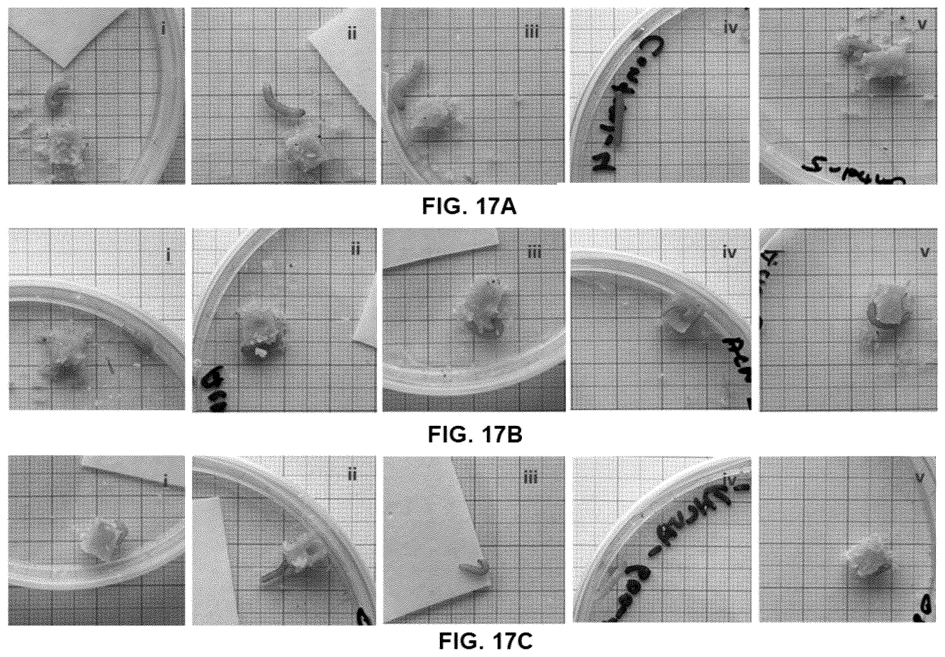

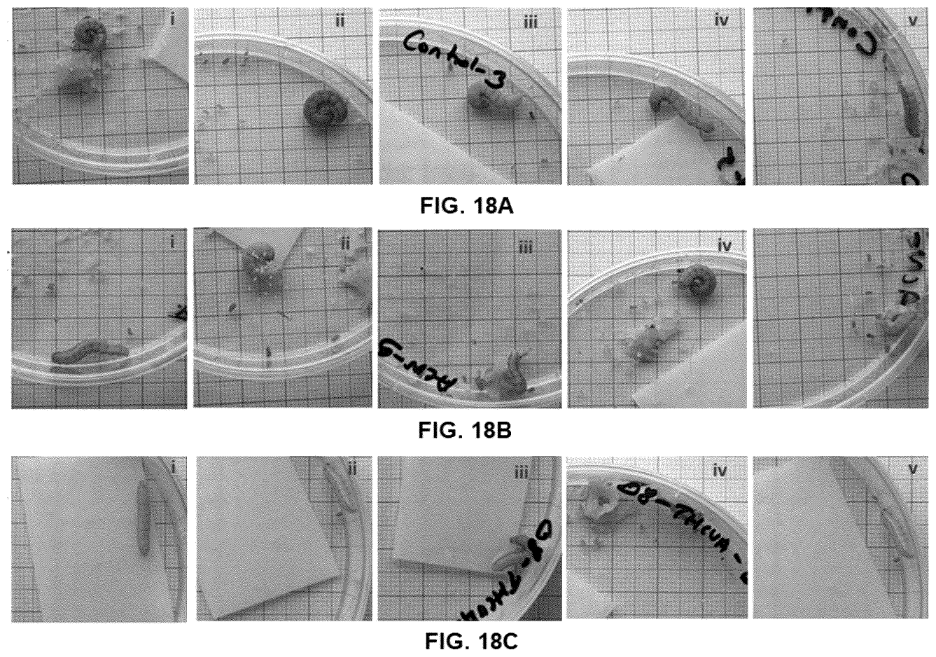

FIGS. 17A-17C demonstrate the visual difference in the size of larvae feeding on Δ⁸-THCVA compared to controls on the 6th day of the experiment. FIGS. 18A-18C also demonstrate the visual difference in the size of larvae feeding on Δ⁸-THCVA compared to controls on the 8th day.

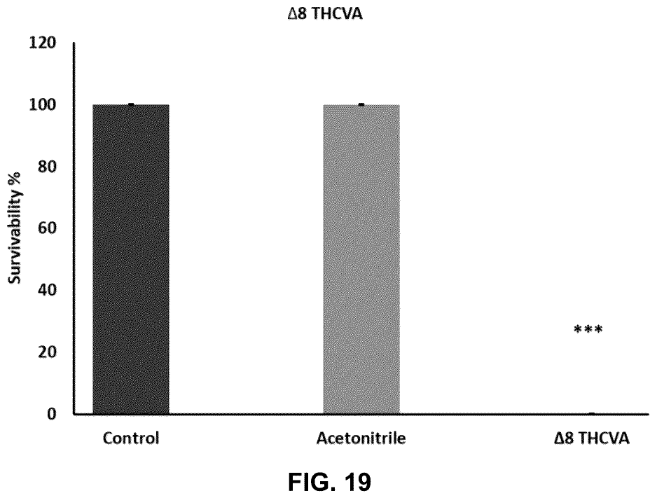

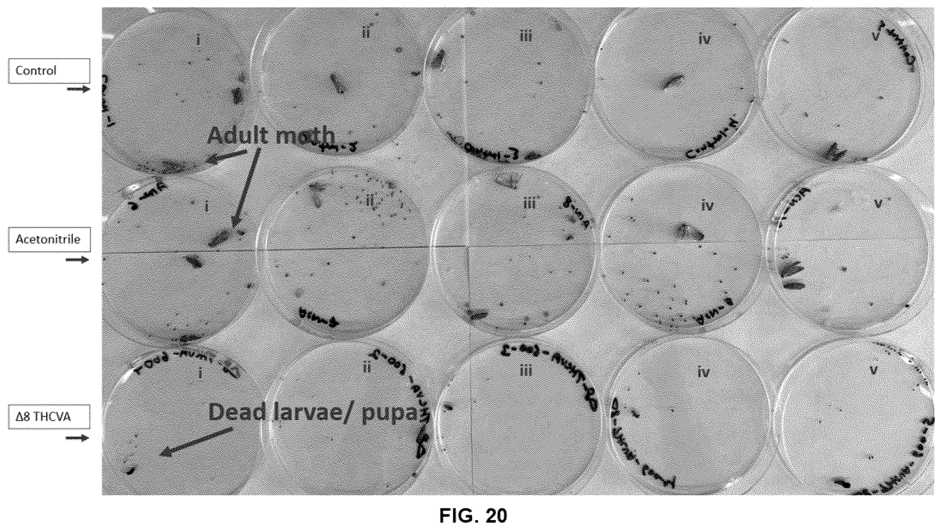

Survivability: Here, the survivability percentage of the larvae from the controls and the Δ⁸-THCVA treatment was calculated (FIG. 19). The successful emergence of a larva into an adult moth is counted as survival. It was found that 100% of the larvae from the control and acetonitrile treatment emerged into adult moths while none of the larvae from the Δ⁸-THCVA treatment emerged as adult moths (FIG. 20), representing 0% survival for the larvae feeding on the Δ⁸-THCVA feed.

### Δ⁸-THCV

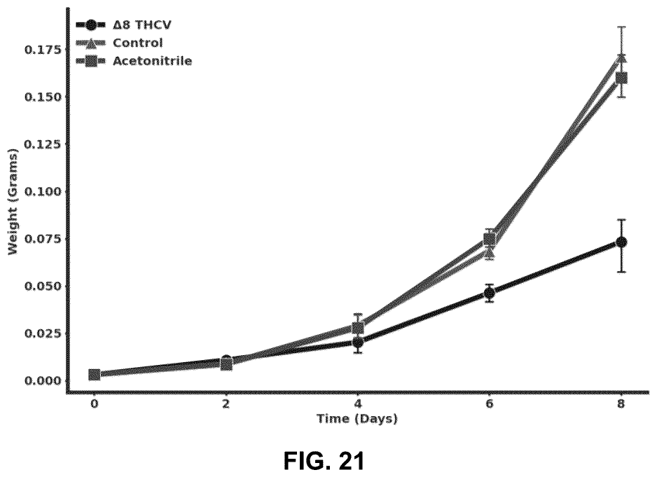

Growth of the larvae: The growth of larvae feeding on Δ⁸-THCV was observed until the 8th day of the experiment. The weight of the same larva was taken at 2 day intervals for the weight comparison between the control feed and the Δ⁸-THCV mixed feed. The result shows no significant difference in weight between the control and Δ⁸-THCV on the 2nd day but on the 4th day onward, larvae feeding on the Δ⁸-THCV had a reduced weight. On the 6th and 8th day, there was a highly significant difference in the weight of larvae feeding on controls and the treatment (FIG. 21).

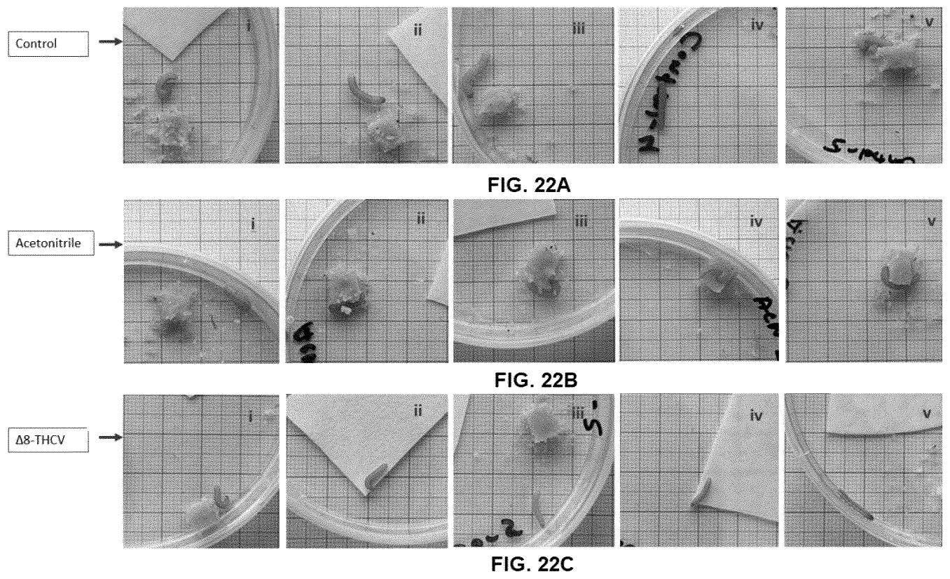

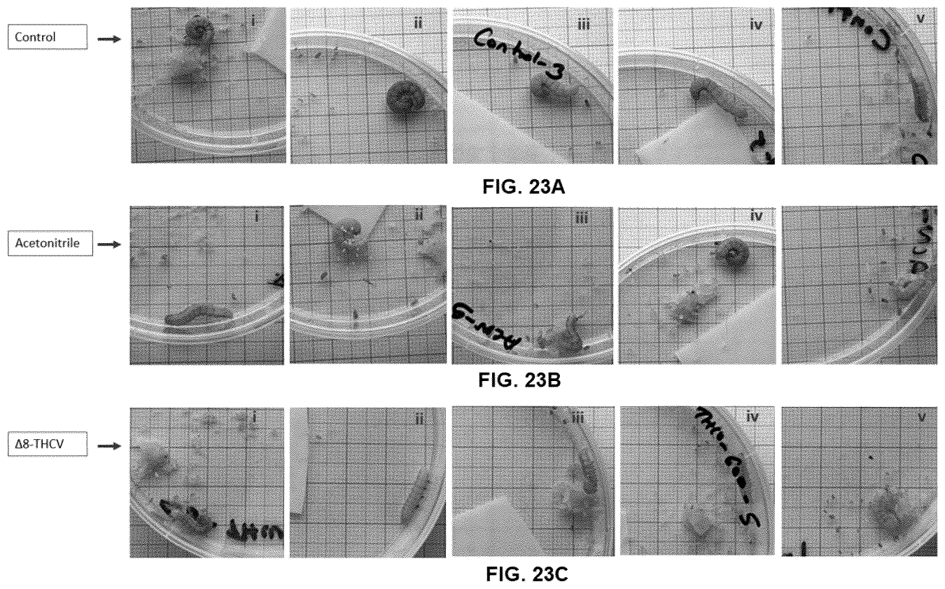

FIGS. 22A-22C demonstrate the visual difference in the size of larvae feeding on Δ⁸-THCV compared to controls on the 6th day of the experiment. FIGS. 23A-23C also demonstrate the visual difference in the size of larvae feeding on Δ⁸-THCV compared to controls on the 8th day.

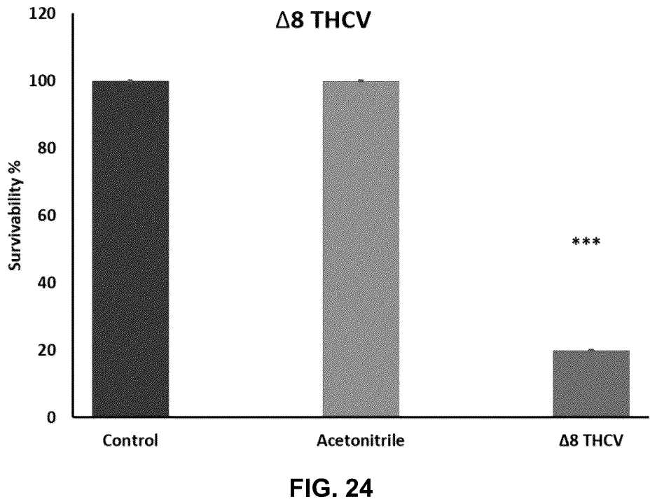

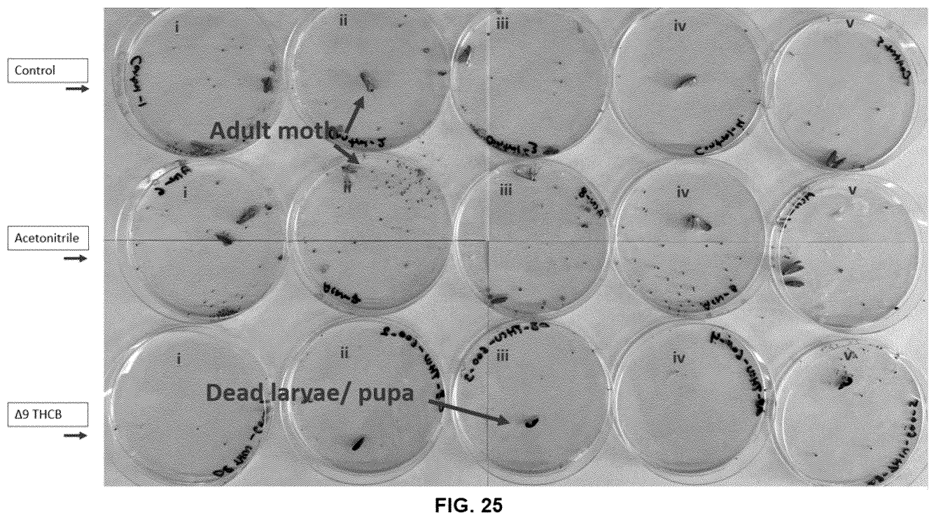

Survivability. Here, the survivability percentage of the larvae from the controls and the Δ⁸-THCV treatment was calculated (FIG. 24). The successful emergence of a larva into an adult moth is counted as survival. It was found that 100% of the larvae from the control and acetonitrile treatment emerged into adult moths while only 20% of the larvae from the Δ⁸-THCV treatment emerged as adult moths (FIG. 25).

### Δ⁹-THCB

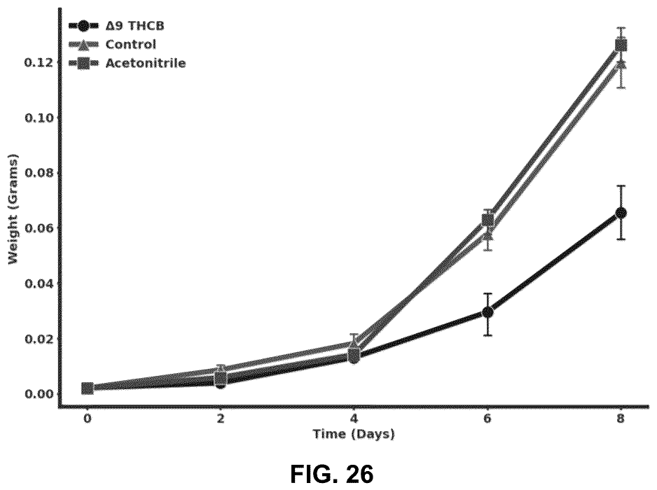

Growth of the larvae: The growth of larvae feeding on Δ⁹-THCB was observed until the 8th day of the experiment. The weight of the same larvae was taken at an interval of every 2 days for the weight comparison between the control feed and the Δ⁹-THCB mixed feed. The result shows no significant difference in weight between the control and Δ⁹-THCB on the 2nd day but on the 4th day and onwards larvae feeding on the Δ⁹-THCB had a reduced weight. On the 6th, and 8th day, there is a highly significant difference in the weight of larvae feeding on controls and the treatment (FIG. 26).

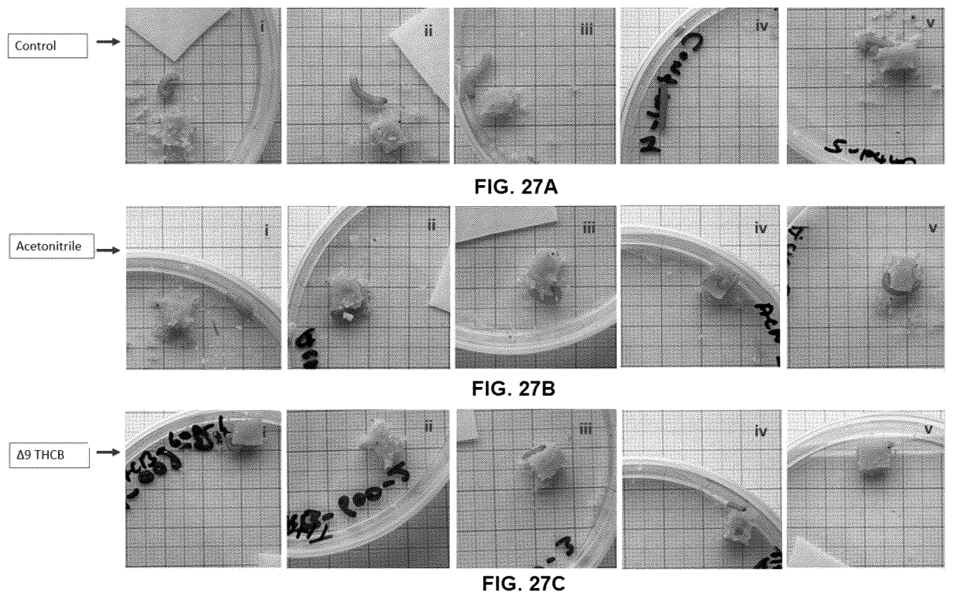

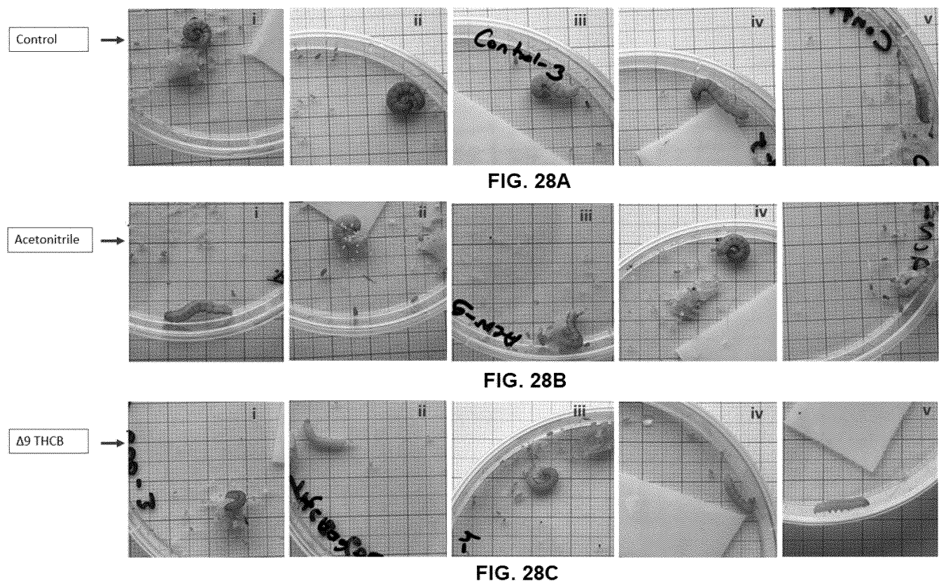

FIGS. 27A-27C demonstrate the visual difference in the size of larvae feeding on Δ⁹-THCB compared to controls on the 6th day of the experiment. FIGS. 28A-28C also demonstrate the visual difference in the size of larvae feeding on Δ⁹-THCB compared to controls on the 8th day.

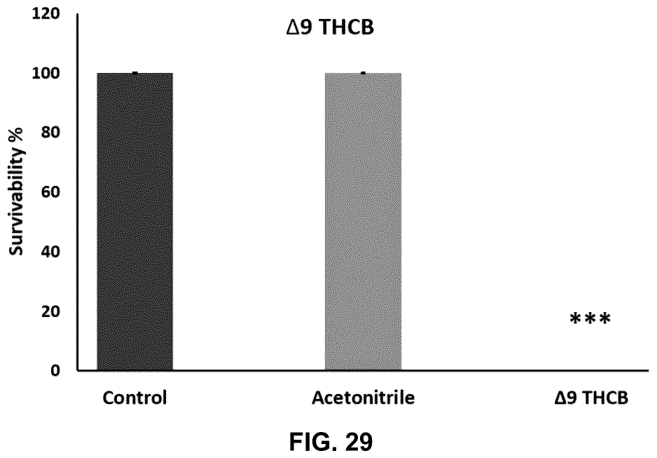

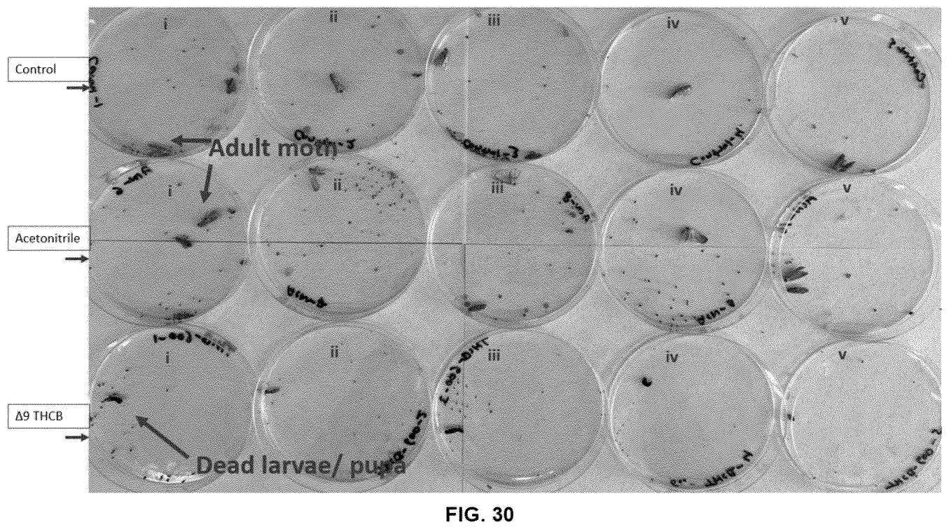

Survivability. Here, the survivability percentage of the larvae from the controls and the Δ⁹-THCB treatment was calculated (FIG. 29). The successful emergence of larvae into an adult moth is counted as survival. It was found that 100% of the larvae from the control and acetonitrile treatment emerged into adult moths while none of the larvae from the Δ⁹-THCB treatment emerged as an adult moth (FIG. 30). 0% survival was observed for the larvae feeding on the Δ⁹-THCB feed.

### Example 3: Discussion

The result of the insect feeding assay demonstrated that some of the minor cannabinoids do possess insecticidal properties. Among all 44 cannabinoids tested from varinol, butol, olivetol, and phorol series, 5 of them possess different levels of insecticidal properties. Among these 5 cannabinoids, Δ⁹-THCB and Δ⁸-THCVA have the highest effect on beet armyworm growth as well as all the larvae feeding on these cannabinoids died before pupation or after pupation. The beet armyworm larvae feeding on the Δ⁹-THCV have a significant reduction in their weight compared to the controls as well as only 20% of the larvae emerge as adult moths. In the same way, Δ⁹-THCVA and Δ⁸-THCV also have significant reduction in the larvae weight and only 40% of the larvae emerge as an adult moth.

This result signifies that these minor cannabinoids may interfere with any of the metabolic pathways of larvae resulting in less feeding that leads to retarded growth. There is also a possibility that these cannabinoids may be interfering with any of the biochemical processes going on in the larvae during larvae growth and mounting. There is a study that claims that varinol cannabinoid Δ⁹-THCV causes loss of appetite in humans and suggests these cannabinoids can be used as weight loss aids.

Since insects do not possess the endocannabinoid receptors CB1 and CB2 found in mammals, it was generally expected that cannabinoids would not affect insects. While the CB1 and CB2 receptors are known to interact with THC and CBD, receptors for more than 100 other cannabinoids remain to be discovered. There is a high possibility that insects may have respective receptors other than CB1 and CB2. A previous study demonstrated that CBD has insecticidal properties at very high concentrations. The larvae of the tobacco hornworm (Manduca sexta) were fed an artificial diet with 1 mM CBD and a high mortality rate was observed. This study also measured the difference in the electrical response in the ganglion of larvae with CBD and without CBD, demonstrating a difference in the voltage in the insect nerve cell. These observations may indicate that larvae may have some sort of receptor that is still to be discovered. There is a possibility insects may have different receptors other than CB1 and CB2 that may affect signal transduction, thus disrupting functions like respiration or gas and water exchanges in the insect.

### Conclusion

The result from the larva-feeding assay demonstrated that 4 of the varinol cannabinoids—Δ⁹-THCVA, Δ⁹-THCV, Δ⁸-THCVA, and Δ⁸-THCV- and one butol cannabinoid-Δ⁹-THCB—have insecticidal properties. There is a possibility that these varinol and butol cannabinoids are synthesized by the cannabis plant as a defense molecule against insect herbivory. If the cannabis plant is automatically synthesizing these varinol cannabinoids as a defense against insect herbivores, then these 4 varinol and one butol cannabinoids could possibly be used as insecticides in different combinations and concentrations.

### Example 4: Effects of Biotic Stress on Cannabinoid Production as an Explanation for Pesticidal Effects of Minor Cannabinoids

### Metabolomics Study

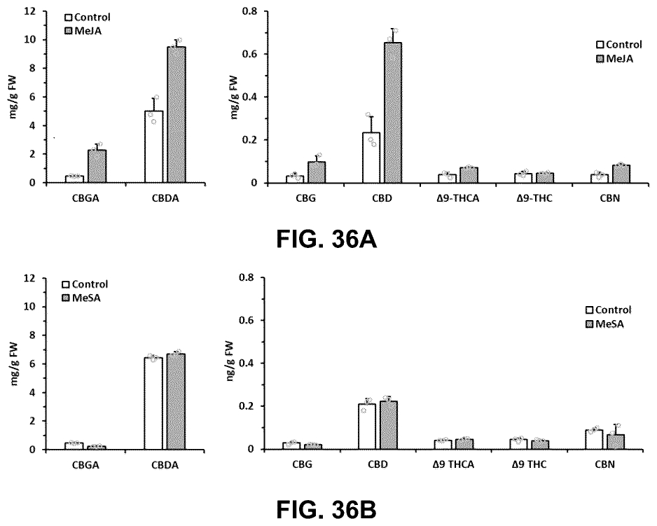

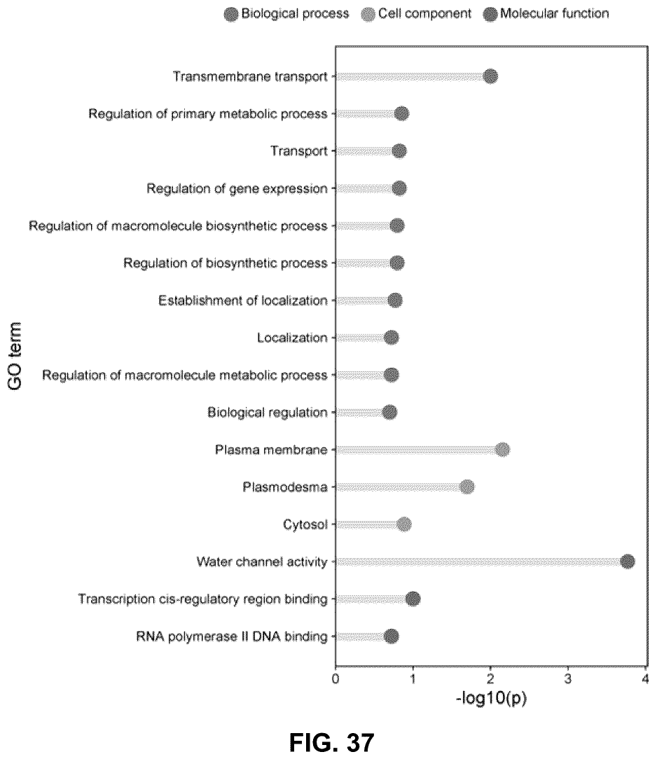

Chemical biotic stress induced by MeJA and MeSA: As a first approach to study the potential effects of different types of biotic stress on the accumulation of cannabinoids in cannabis, a series of experiments were conducted using the signaling compounds MeJA and MeSA, which are known to be involved in the induction of plant defense responses towards biting-chewing and piercing-sucking insects, respectively. Remarkably, the present analysis of flowers from MeJA treated cannabis plants demonstrated that the levels of most major cannabinoids were significantly increased compared to control plants (FIG. 36A). In MeJA-treated plants the accumulation of CBGA and CBG was 4.8- and 3-fold increased, respectively, and levels of CBDA and CBD were 1.9- and 2.8-fold higher, respectively. While the amount of Δ⁹-THCA was 1.8-fold increased upon MeJA treatment no significant change was observed for its neutral form Δ⁹-THC, however, the level of its derivative CBN was 2.2-fold higher. In contrast, no significant differences were observed in the accumulation of cannabinoids in flowers of MeSA treated cannabis plants compared to the control (FIG. 36B) except for CBGA which was found at approximately 50% lower levels.

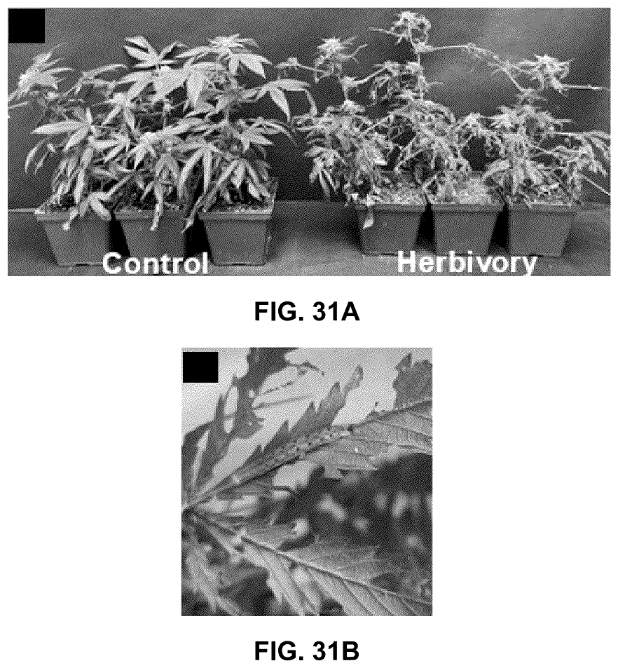

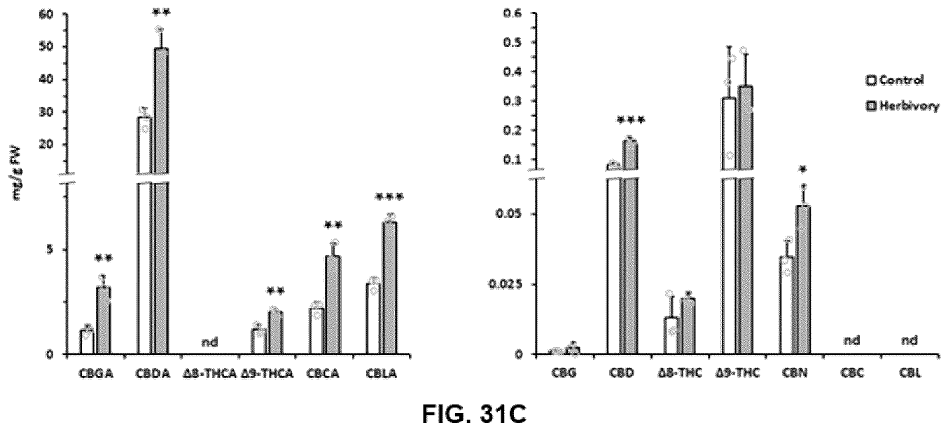

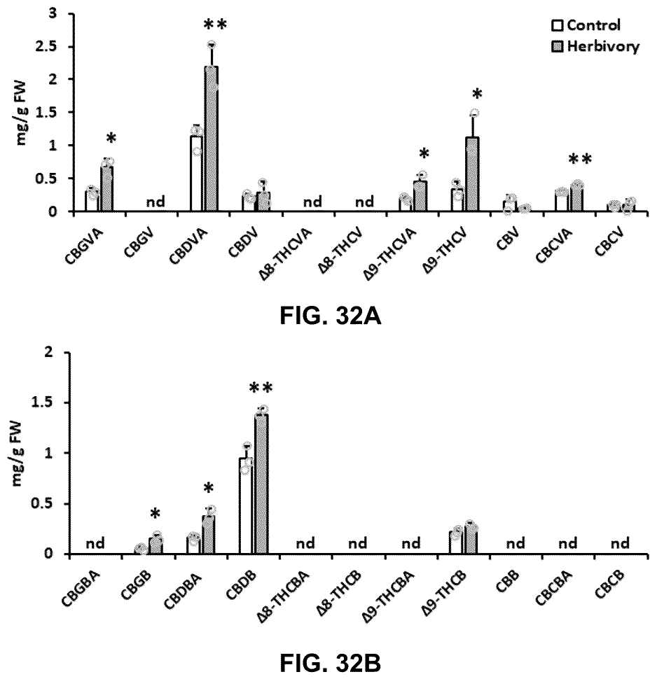

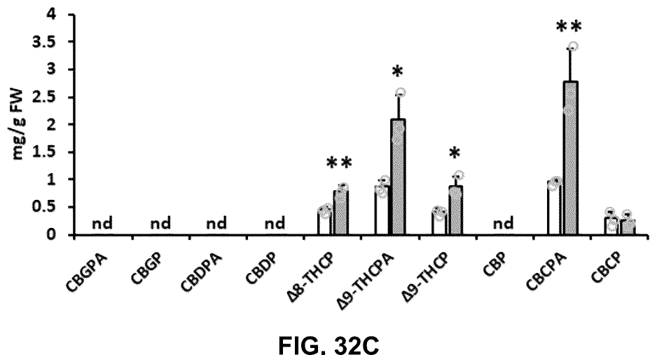

Insect herbivory affects the profile of major cannabinoids in hemp: The results from the MeJA treatment, which mimics biotic stress induced by biting-chewing insects, led to an investigation of the effect of actual herbivory on cannabinoid and terpene profiles. Thus, the SSH hemp cultivar, which is dominant in olivetol series cannabinoids, was used for feeding experiments with S. exigua larvae (FIGS. 31A-31B). Quantitative analysis demonstrated that many olivetol series cannabinoids accumulate at higher levels in hemp flowers upon larval herbivory (FIG. 31C). Upon herbivory the amount of CBGA, the precursor of all olivetol cannabinoids, was 2.8-fold increased, while the small amount of its neutral form CBG remained unchanged. In flowers of plants exposed to herbivory the accumulation of CBDA and CBD was 1.7- and 2-fold increased, respectively, while that of the derivative Δ⁸-THC was not significantly changed. Only the amount of 49-THCA was 1.7-fold increased upon herbivory but not of its neutral form Δ⁹-THC, however, the level of its derivative CBN was 1.5-fold higher. In addition, the third olivetol series cannabinoid CBCA and its derivative CBLA accumulated at 2.1- and 1.9-fold higher levels upon herbivory.

Herbivory also affects accumulation of some minor cannabinoids (varinol, butol, and phorol series): To provide a broad perspective of larvae's herbivory on the cannabinoid profile, all the identified minor cannabinoids from the varinol, butol, and phorol series were also quantified. The results demonstrated that some of the detected varinol cannabinoids were up-regulated. The first precursor molecule of the varinol cannabinoids biosynthesis pathway, CBGVA, is increased twofold while the other downstream acidic forms, like CBDVA and Δ⁹-THCVA, are also significantly increased twofold. The neutral form Δ⁹-THCV is upregulated more than 3-fold, while CBDV, CBV, and CBCV do not have significant changes compared to the control. In the same way, from the butol series cannabinoid, CBGB, CBDBA and CBDB are up-regulated 2.6-, 2.3- and 1.5-fold, respectively, and other detected neutral cannabinoids like Δ⁹-THCB had no significant changes compared to the control. For the phorol series, Δ⁹-THCPA and Δ⁹-THCP are upregulated twofold, Δ⁸-THCP 1.8-fold, and CBCPA 2.9-fold, while CBCP has no significant changes compared to the control.

### Transcriptomics

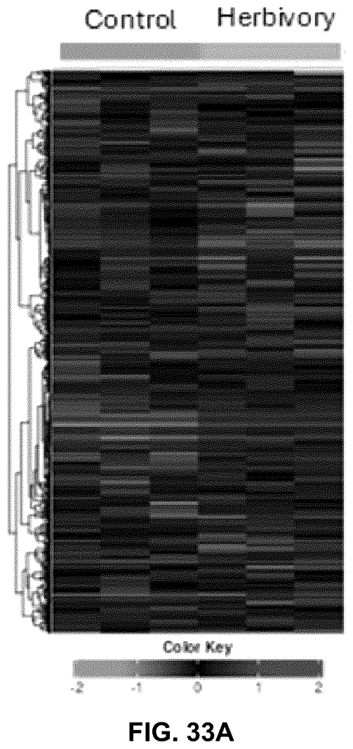

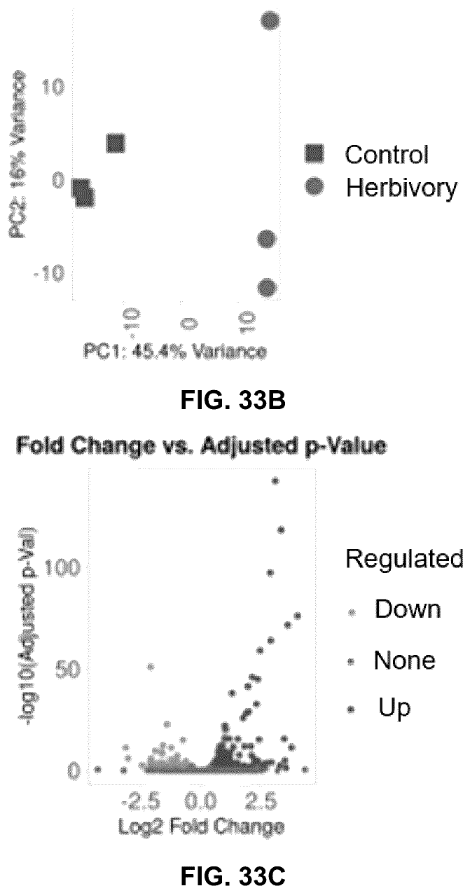

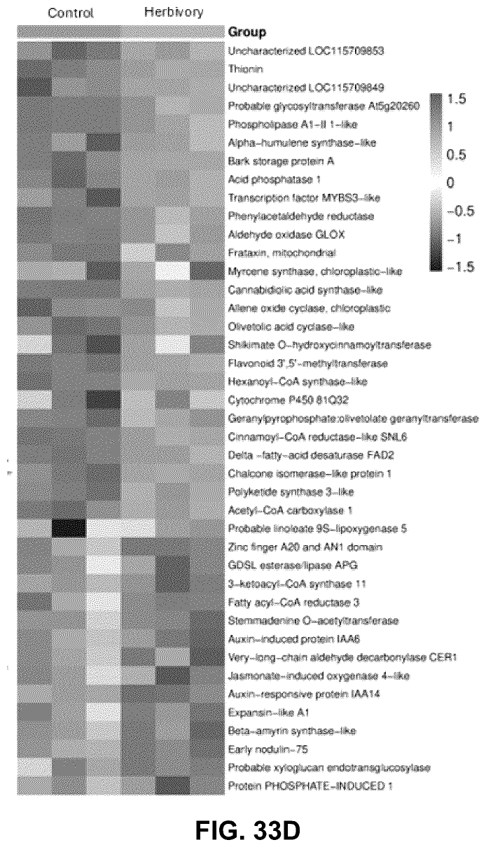

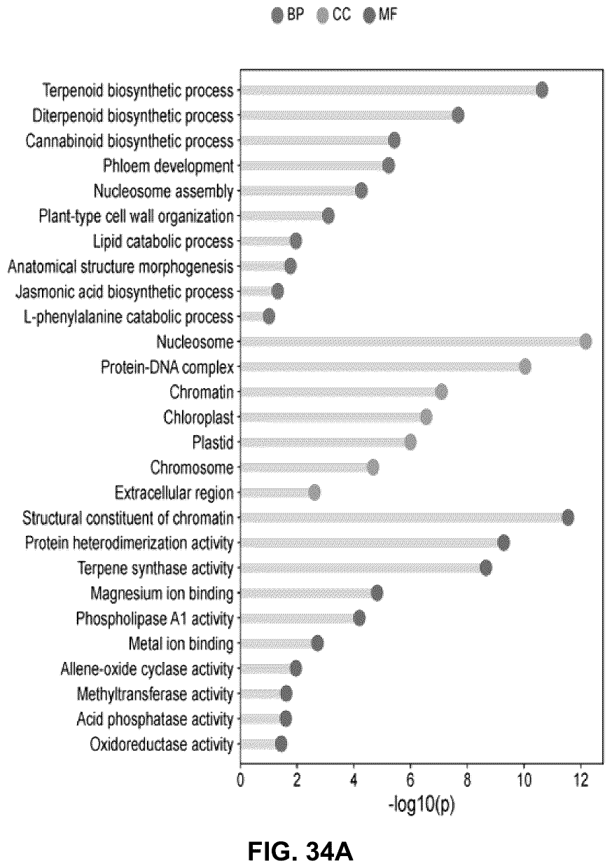

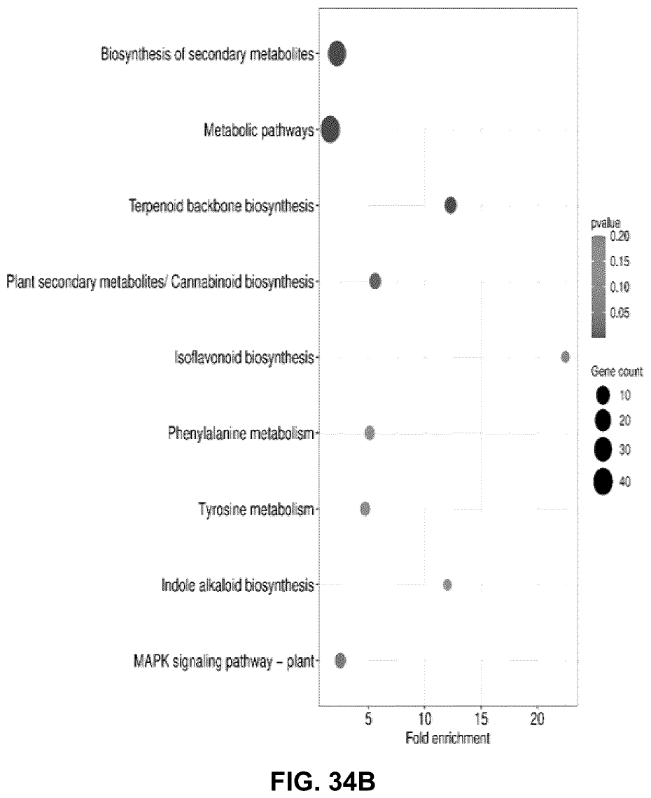

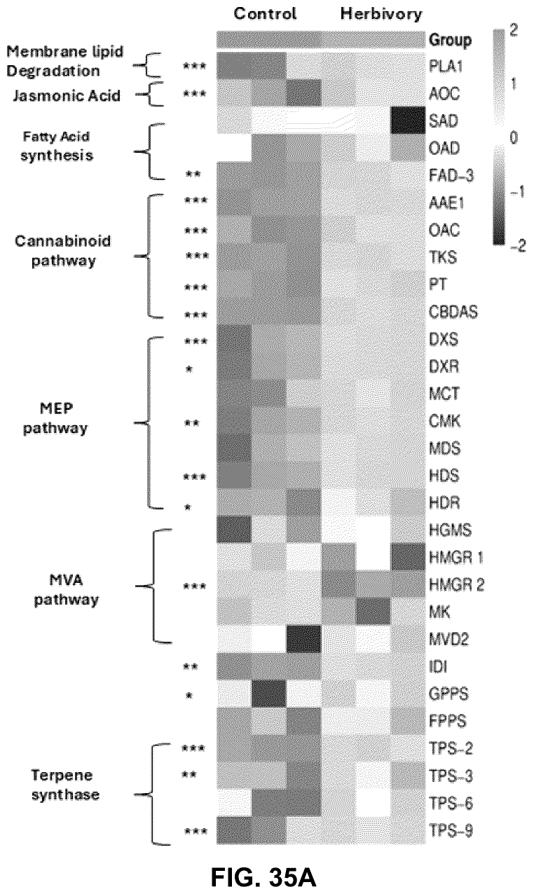

Differentially expressed Genes (DEG): RNA sequencing was done to obtain a comprehensive overview of the transcript changes between the control and the larvae herbivory. The RNA sequence count data were analyzed for the differentially expressed genes (DEG) with the iDEP online software. A DESeq2 inbuilt package was used for DEG analysis, with FDR<0.05 and fold change of >1.5 and found 188 differentially expressed genes. The volcano plot visualizes the number of upregulated and downregulated genes (FIG. 33A). The PCA analysis shows that the control and larvae herbivory were separated in the PC1 and PC2 score plot, accounting for 47% of the variability between the samples (FIG. 33B). Out of 188 differentially expressed genes, a heat map of the top 41 genes, 27 upregulated genes, and 14 down regulated genes was plotted (FIG. 33C).

Gene ontology and pathway enrichment analysis: To get an overview of the insect herbivory on the biological process, cellular component, and molecular function at the transcript level, gene ontology (GO) was performed with the upregulated and down-regulated DEG. The results from the GO demonstrate that the terpenoid and cannabinoid biosynthesis process was highly enriched. The jasmonic acid biosynthesis process and lipid catabolic process are also enriched. The result showed that cellular component genes related to nucleosome, chromatin, and chromosome were highly enriched. The molecular function analysis shows that the structural constituent of chromatin, phospholipase activity, and allene oxide cyclase activity were highly enriched. In the same way, results from the KEGG pathway analysis demonstrated that, among the secondary metabolites, metabolic pathway, terpenoid backbone biosynthesis, and the plant secondary metabolites/cannabinoid biosynthesis pathways were significantly enriched.

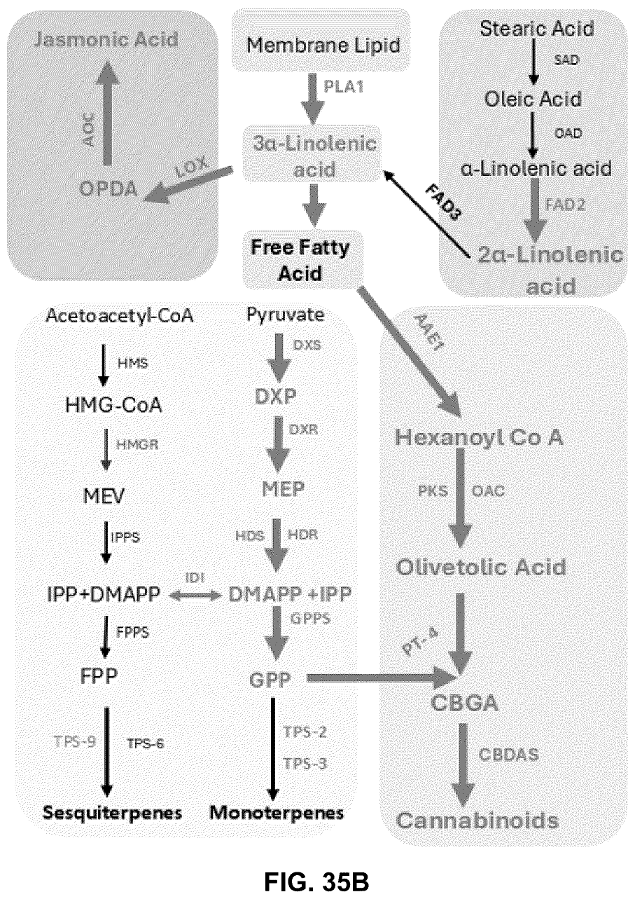

Direction of metabolite flux in response to insect herbivory: The gene ontology suggests that terpenoid, and polyketide pathway along with jasmonic acid, and lipid degradation biosynthesis process were highly enriched in response to insect herbivory. As these are the upstream pathways of cannabinoid biosynthesis and it depends on these pathways for precursor molecules. Moreover, there is crosstalk and tradeoff precursor between these pathways, so to get an overview of the direction of metabolite flow in response to insect herbivory, transcript profiles of all genes involved in these pathways were analyzed. The transcript profile of all the genes involved in these pathways was extracted and a heat map was generated (FIG. 35A). While visualizing the direction of metabolite flux, an illustration diagram was created (FIG. 35B). The arrows show the genes upregulated and/or downregulated by insect herbivory. Starting with the membrane lipid degradation pathway PLA1 is upregulated and in jasmonic acid signaling pathway both LOX and AOC were upregulated. In the de novo fatty acid synthesis pathway only FAD2 is up-regulated. While in the polyketide pathway all four genes AAE1, PKS, OAC, PT, and in downstream cannabinoid pathway CBDAS were upregulated. At the same time in the MEP pathway which shares the precursor with the downstream cannabinoid pathway, rate limiting gene DXS and other downstream gene DXR, HDS, IDI, HDR and GPPS were upregulated. In the MVA pathway HMGR gene were down regulated while most of the other genes from MVA pathway have no significant response to insect herbivory. The above diagram clearly visualizes the direction of flow of metabolites in response to insect herbivory. The upregulated metabolites from upstream fatty acid pathway flow to polyketide pathway and at the same time the up-regulated metabolites from MEP pathway funneled to downstream cannabinoid pathway.

### Cannabinoid Insecticidal Activity Assay

The metabolomic and transcriptomics study suggest the cannabis plant is intentionally upregulating the cannabinoid pathway in response to insect herbivory. This result prompted a further investigation of whether any of these upregulated cannabinoids possess insecticidal properties.

Cannabinoid insecticidal activity assay on the beet armyworm larvae: The insecticidal activity assay was performed on beet armyworm with the pure cannabinoids from varinol, butol, olivetol and phorol series to determine if any of the upregulated or non-regulated cannabinoids possess insecticidal or antifeedant properties. The results from the insecticidal activity assay demonstrated that some cannabinoids do have insecticidal or antifeedant properties. The larvae feeding on the four of the varinol cannabinoids Δ⁸-THCVA, Δ⁸-THCV, Δ⁹-THCVA, and Δ⁹-THCV have significantly reduced weight compared to the acetonitrile control (solvent control) on the 8th day from the start of the experiment. While the larvae feeding on the CBGVA, CBGV, CBDVA, CBDV, CBCVA, CBCV, and CBV do not have any significant effect on the larvae growth and development. The larvae feeding on one of the butol cannabinoids, Δ⁹-THCB have significant reduction in the weight compared to the acetonitrile control while the larvae feeding on CBGBA, CBGB, CBDBA, CBDB, Δ⁸-THCB, CBCBA, CBCB and CBB have no significant effect on the larvae growth and development. In the same way the larvae feeding on the olivetol cannabinoids, CBGA, CBG, CBDA, CBD, Δ⁹-THCA, CBCA, CBLA, CBL, CBNA, and CBN do not have significant weight reduction compared to acetonitrile control but instead the larvae feeding on Δ⁹-THC and CBC have significant increase in the weight on the eighth day from the start of experiment. The larvae feeding on the phorol cannabinoids, CBGPA, CBGP, CBDPA, CBDP, Δ⁹-THCPA, Δ⁹-THCP, CBCPA, CBCP and cannabiphorol do not have any significant effect on the larvae weight compared to acetonitrile control.

Effect of cannabinoids on weight and the survivability of larvae: The results from the insecticidal activity assay done on 45 cannabinoids from varinol, butol, olivetol, and phorol series cannabinoids have demonstrated that five cannabinoids Δ⁸-THCVA, Δ⁸-THCV, Δ⁹-THCVA, Δ⁹-THCV and Δ⁹-THCB have insecticidal or antifeedant properties. The larvae feeding on these cannabinoids have significant reduction in growth and development affecting their survivability. The larvae feeding on Δ⁸-THCVA have significant reduction in their weight at 4th, 6th and the 8th days from the start of experiment while all the larvae died in between 14-16th day leading to zero % survivability. The larvae feeding on the Δ⁸-THCV have significant reduction in weight on 6th and 8th days while 80% of the larvae died in between 14-16 days leading to 20% survivability. Similarly, larvae feeding on the Δ⁹-THCVA have significant reduction in weight on 6th and 8th days while 60% of the larvae died in between 18-19 days leading to 40% survivability. In the same way, larvae feeding on the Δ⁹-THCV have significant reduction in weight on the 4th, 6th and 8th days while 80% of the larvae died in between 17-18 days leading to 20% survivability. Similarly, larvae feeding on the Δ⁹-THCB have significant reduction in weight on the 6th and 8th days while all of the larvae died in between 13-15 days leading to zero % survivability. In the same way, larvae feeding on the Δ⁹-THC have significant increase in weight on 6th and 8th days while all of the larvae survived leading to 100% survivability.

### Discussion

The results from the biotic stress inducer experiment showed that spraying methyl jasmonate, which simulates chewing-type insect herbivory, upregulates cannabinoid production. In contrast, the results from methyl salicylate treatment, which mimics pathogen and sucking type insect attacks on plants, did not enhance cannabinoid synthesis. These findings align with a literature observation of downregulation of cannabinoid synthesis in cannabis inflorescences at 0.1 mM and 10 mM. However, increased CBDA synthesis has also been reported following salicylic acid application, which contradicts these results. Moreover, the present results also align with another study assessing the effect of cannabis aphids on the cannabinoid profile shows that none of the cannabinoids were significantly upregulated as aphids being a sucking type insect upregulated salicylic acid pathway. This experiment confirmed that only methyl jasmonate enhances cannabinoid production, leading to a further investigation of insect herbivory's direct effects on the cannabis cannabinoid profile.

The results from the quantification of olivetol series cannabinoids demonstrated that larvae herbivory upregulates cannabinoid biosynthesis. The insect herbivory upregulated the production of CBGA, the first precursor molecule in cannabinoid biosynthesis, along with its acidic derivatives, including CBDA, Δ⁹-THCA, CBCA, and CBLA. Several studies suggest that plants increase the biosynthesis of secondary metabolites in response to insect herbivory. In the same way, cannabis plants may have increased cannabinoid production as a defense mechanism against insect herbivory. Field studies reported that higher CBD concentrations in leaves deter larval herbivory. Additionally, feeding trials with pure CBD and Δ⁹-THC suggest that these cannabinoids may exhibit insecticidal properties at higher concentrations. However, other studies contradict these findings, claiming that CBD and THC do not possess insecticidal properties. Instead, they attribute insecticidal effects to terpenes like caryophyllene, which have been reported to have insecticidal properties.

Quantification of varinol, butol, and phorol series cannabinoids revealed that some cannabinoids from these series were upregulated in response to insect herbivory. To date, no studies have investigated effects of insect herbivory on the biosynthesis of varinol, butol, or phorol cannabinoids. This study provides the first evidence that herbivory upregulates the synthesis of cannabinoids from these series. Specifically, insect herbivory upregulated CBGVA and its downstream derivatives, CBDVA and Δ⁹-THCVA along with neutral cannabinoid Δ⁹-THCV. Similarly, butol-series cannabinoids, including CBDBA and CBGB, were upregulated, making this the first study to report such findings. Phorol cannabinoids, including Δ⁹-THCPA and Δ⁹-THCP were upregulated following insect herbivory, marking the first study to report the upregulation of phorol cannabinoids in cannabis in response to insect herbivory. Notably, 49-THCB, a butol cannabinoid, exhibits threefold greater affinity for the CB1 receptor while phorol cannabinoid, Δ⁹-THCP binds cannabinoid receptors with 33-fold higher affinity than Δ⁹-THC. The presence and upregulation of butol and phorol cannabinoid in response to insect herbivory could enhance or alter the psychoactive or therapeutic properties of cannabis. Current evaluations of cannabis medicinal and recreational properties rely solely on Δ⁹-THC and CBD levels from the olivetol series. These findings underscore the need to include these butol and phorol series cannabinoids for a more comprehensive evaluation of cannabis's pharmacological potential.

Transcriptomic analysis revealed significant upregulation of numerous genes associated with both direct and indirect plant defense responses. Additionally, several uncharacterized genes were strongly upregulated. However, the biosynthetic genes for varinol, butol, and phorol cannabinoids remain unidentified. It is still unclear whether these minor cannabinoids are synthesized by the same enzymes involved in olivetolic cannabinoid biosynthesis or are regulated by distinct genes.

Gene Ontology and KEGG pathway enrichment analyses showed significant enrichment of terpenoid and cannabinoid biosynthesis processes, along with membrane lipid degradation by phospholipase A1 activity, in response to insect herbivory. These findings support the hypothesis that cannabis actively upregulates cannabinoid biosynthetic pathways under herbivory stress, suggesting a potential defensive role of cannabinoids against insect attack.

Metabolite flow visualization under insect herbivory revealed metabolic flux directed towards cannabinoid biosynthesis, indicating that cannabis intentionally upregulate cannabinoid production. The PLA1 gene, involved in membrane degradation, was upregulated 11-fold, leading to increased production of 3α-linolenic acid, a precursor for both the jasmonic acid signaling pathway and the polyketide pathway. Since increased 3α-linolenic acid leads to an increased free fatty acid pool. Increased free fatty acid pools likely funnel fatty acid intermediates into the polyketide pathway leading to cannabinoid formation. Notably, all four key genes of the polyketide pathway (AAE1, OAC, TKS, and PT) were upregulated, resulting in full (100%) pathway enrichment. Concurrently, the MEP pathway was also induced, consistent with a literature report showing upregulation of the rate-limiting DXS gene along with DXR, HDS, HDR, and GPPS, enhancing GPP production—a key cannabinoid precursor. In contrast, the HMGR gene of the MVA pathway was downregulated, differing from another study observing MVA pathway activation under biotic stress. These results suggest that cannabis selectively activates the MEP pathway, likely to meet the increased GPP demand for cannabinoid biosynthesis. This metabolic reprogramming implies that cannabis prioritizes cannabinoid production and storage as a primary defense strategy against insect herbivory, similar to nicotine in tobacco and glucosinolates in Brassica species.

The results from the insecticidal activity assay which was conducted to see if any of the upregulated cannabinoids have insecticidal properties have demonstrated that four varinol and one butol series cannabinoid exhibit varying degrees of insecticidal properties. These findings suggest that these varinol cannabinoids may be synthesized by cannabis plant as a natural defense mechanism, possibly functioning as antifeedants against insect herbivores. These results can also be supported by the study on mice that has shown that Δ⁹-THCV can suppress appetite, and there is an ongoing clinical trial investigating its potential as an anti-obesity drug. There are many studies that have focused only on CBD and THC and have claimed cannabinoids have insecticidal properties and some have denied but all these studies have ignored the cannabinoids from the varinol, butol, and phorol series. Although insects lack CB1 and CB2 cannabinoid receptors, it is possible that they possess yet-undiscovered receptors that interact with cannabinoids. Furthermore, existing research suggests that cannabinoids can also interact with other molecular targets that are crucial for insect growth and development, such as TRP, GABA, opioid, and nicotine receptors, which may explain their biological activity in insects.

If these cannabinoids serve a defensive role, one might wonder why the cannabis plant produces them only in trace amounts instead of in higher concentrations. A likely explanation lies in the plant's long history of domestication—cannabis is one of the oldest domesticated crops, with human use dating back over 13,000 years. During this extensive period of cultivation and selective breeding, the genetic diversity of cannabis may have been significantly reduced. It is possible that ancient germplasm once rich in varinol cannabinoids has been lost over time through domestication. Early humans may have unintentionally selected cannabis strains rich in olivetol-based cannabinoids, such as THC and CBD, for their desirable psychoactive and therapeutic effects. In contrast, varinol cannabinoids are less suited for recreational use, as they differ significantly in psychoactivity—varinol compounds are estimated to have roughly half the psychoactivity of THC, butol-series cannabinoids about three times more, and phorol-series cannabinoids up to 33 times higher. This heightened psychoactivity may have made these compounds less favorable for early human use, leading to their gradual exclusion from cultivated varieties.

### Conclusion

The metabolomic analysis revealed that most olivetol and varinol series cannabinoids, along with some butol and phorol series cannabinoids, were upregulated in response to insect herbivory. Transcriptomic data further demonstrated that cannabis upregulates MEP, polyketide and downstream cannabinoid biosynthetic pathways, along with its upstream fatty acid pathway. The gene ontology and KEGG pathway enrichment analysis suggest that the cannabis plant may be intentionally upregulating the cannabinoid pathway to protect the cannabis plant from insect herbivory. Moreover, insecticidal activity assay demonstrated that the four varinol cannabinoids, Δ⁸-THCVA, Δ⁸-THCV, Δ⁹-THCVA, and Δ⁹-THCV, and one butol cannabinoid, Δ⁹-THCB, do possess insecticidal properties. These results from metabolomics, transcriptomics and insecticidal activity assay indicates that, in response to insect herbivory, cannabis plant may have been upregulating cannabinoid biosynthesis pathway particularly to increase the concentration of certain cannabinoids to defend itself. This may lead to the upregulation of other cannabinoids due to a spillover effect and may be the reason for the cannabis plant getting hot (Δ⁹-THC above 0.3%). The actual function of cannabinoid may be to defend the cannabis plant against biotic stress like insect herbivory.

### Materials and Methods

Plant material and growth conditions: For all experiments the CBD-type hemp variety Sour Suver Haze (SSH) was used. Seeds of the SSH hemp variety were obtained from Jack Hempicine LLC (Independence, OR) and initially used to grow mother plants. For the selection of female plants total genomic DNA was isolated from individual plants and a PCR test with the sex-associated molecular marker MADC2 was performed as described previously. To ensure genetic uniformity between plants used as control and for treatments, all plants used for experiments were propagated vegetatively via cuttings from a confirmed female mother plant. Approximately 15 cm long branches were cut from the mother plant, the base of the cutting treated with rooting hormone (Hormondin, OHP Inc.), inserted into moist rock wool for further cultivation, and covered with a transparent dome to minimize moisture loss. When roots developed, cuttings were transplanted into soil in 4-inch square pots. The potted plants were then moved to a greenhouse under long-day conditions (18 h light, 6 h darkness) for further vegetative growth for three weeks. In week 4, the photoperiod was adjusted to short-day conditions (10 h light, 14 h darkness) to induce flowering. Once flowers developed the plants were used for experiments.

Methyl jasmonate and methyl salicylate treatments: Methyl jasmonate (MeJA) and methyl salicylate (MeSA) were used to mimic different types of biotic stress. For the MeJA treatment hemp plants were sprayed with a 2 mM MeJA solution (in 25% ethanol) every 12 hours for 3 days. Likewise, for the MeSA treatment plants were sprayed with a 4 mM MeSA solution (in 25% ethanol) every 12 hours for 3 days. For both experiments control and treated plants were placed in separate greenhouse units under identical environmental conditions. After three days of MeJA and MeSA treatment, respectively, flower buds were harvested and used for the quantification of cannabinoids.

Insect herbivory. First-instar beet armyworm (Spodoptera exigua) larvae were purchased from Benzon Research Inc. (Carlisle, PA, USA) and reared on an artificial diet at room temperature until they reached the third instar stage. Once hemp plants had developed to the early flowering stage, with all stigmas fully protruding, plants were used for herbivory treatment. Plants were placed in a nylon mesh cage and beet armyworm larvae were allowed to feed on leaves and flowers for 3 days. Control plants were housed separately in nylon mesh cages but without larvae. On the fourth day, flower buds were harvested and used for further analysis.

Storage and processing of flower material: The harvested flower buds were kept in 50 mL tubes, immediately flash-frozen in liquid nitrogen, and stored at −80° C. To process the harvested flowers the frozen tissue was pulverized inside the tubes using a metal pestle under liquid nitrogen. The resulting pulverized flower tissue served as a stock, from which samples were taken for RNA isolation, as well as extraction of cannabinoids and terpenes.

Cannabinoid extraction and analysis: For the extraction of cannabinoids 1 g of pulverized frozen flower tissue was transferred into a 50 ml tube and 10 ml of a 9:1 methanol-chloroform mixture added. Samples were vortexed for 1 min, then sonicated for 10 min, centrifuged at 4000 rpm for 5 min, and the supernatant collected in a new 50 mL tube. The remaining plant tissue was subjected to two additional extractions using the same procedure and supernatants from all three extractions were pooled. 2 mL of the pooled extract was transferred into a 15 ml tube, and the solvent evaporated using a gentle stream of nitrogen gas. After evaporation, 1 mL acetonitrile was added to dissolve cannabinoids. The solution was then serially diluted by transferring 0.5 mL into a new test tube, adding 0.5 mL of acetonitrile, and mixing thoroughly. This dilution step was repeated twice, and the final 1 mL solution was filtered through a 0.21-micron nylon filter. Filtered extracts were transferred into 1.5 mL glass vials and stored at −20° C. until analysis by LC-MS.

Liquid chromatography (LC) coupled with a mass spectrometer (MS) was used to separate and identify cannabinoids. A literature method was followed with modification. Chromatographic separation was performed using a Thermo Dionex Integrion High Performance Ion Chromatography System (Thermo Fisher Scientific, Waltham, MA) equipped with a NexLeaf CBX Potency C18 column (2.7 μm, 150×4.6 mm) (Shimadzu, Columbia, MD). The oven temperature was maintained at 40° C., water with 0.1% (v/v) formic acid used as mobile phase A, and acetonitrile with 0.1% (v/v) formic acid as mobile phase B. The LC run method included a run time of 24 min, with data acquisition between 5 and 18 min. The flow rate was set to 1 mL/min, and a PDA spectrum (190-230 nm) was used for detection. Gradient flow 0.01-0.5 minutes; 50% of B, 0.5-14 minutes; 90% of B, 14-20 minutes; 10% of B, 20-21 minutes; 100% of B, 21-22 minutes; 60% of B, 22-23 minutes; 50% of B, 24 minutes stop. Mass spectrometric analysis was performed using a Thermo Scientific Q Exactive Quadrupole Orbitrap High-Resolution Mass Spectrometer (Thermo Fisher Scientific, Waltham, MA). Data acquisition was conducted in data-dependent acquisition (DDA) mode for both positive and negative ion modes. Xcalibur software was used to acquire data, and freeStyle software was used to identify and quantify the peak compared with the authentic cannabinoid standards. Cannabinoid compounds were identified by comparing their mass spectra of authentic cannabinoid standards.

Cannabinoid chemical standards: The chemical standards used for the identification and quantification of individual cannabinoid compounds were purchased from Sigma Aldrich (St. Louis, MO) and Cayman Chemicals (Ann Arbor, MI). Sigma Aldrich: CBGA (C-142), CBG (C-141), Δ⁹-THCA (T-093), CBDA (C-144). Cayman Chemicals: Δ⁹-THC (12068), Δ⁸-THCA (35277), Δ⁸-THC (60158), CBN (60183), CBNA (21734), CBD (90080), CBCA (37558), CBC (60163), CBLA (35745), CBL (22036), CBE (21092), CBGVA (29787), CBGV (29117), Δ⁹-THCVA (21259), Δ⁸-THCVA (28580), Δ⁹-THCV (18091), Δ⁸-THCV (38795), CBV (21664), CBDVA (30245), CBDV (20165), CBCVA (32718), CBCV (21974), CBGBA (29136), CBGB (29109), Δ⁹-THCBA (29309), Δ⁹-THCB (33078), Δ⁸-THCBA (41301), Δ⁸-THCB (37898), CBB (29303), CBDBA (29032), CBDB (32719), CBCB (29311), CBCBA (29308), CBGPA (30313), CBGP (30312), Δ⁹-THCPA (36239), Δ⁹-THCP (33691), Δ⁸-THCP (35467), CBDPA (36237), CBDP (33611), CBCPA (39459), CBCP (36541), CBP (37006).

RNA isolation and qRT-PCR analysis: For the isolation of total RNA 50 mg of pulverized flower tissue was used. RNA isolation was performed using the Spectrum Plant Total RNA Kit (Sigma Aldrich, St. Louis, MO) essentially following the manufacturer protocol with slight modifications. Room temperature isopropanol was used for RNA precipitation to prevent precipitation of resin which is highly abundant in hemp flower tissue. The quality and quantity of the isolated RNA was determined spectrophotometrically using a NanoDrop (Thermo Fisher Scientific, Waltham, MA). The synthesis of cDNA was performed using oligo dT primer and reverse transcriptase as described previously. qRT-PCR reactions were conducted in a 20 μL total volume using the PowerUp SYBR Green Master Mix (Applied Biosystems, Waltham, MA) and run on an ABI 7500 qPCR thermocycler (Applied Biosystems, Waltham, MA). The constitutive housekeeping gene Elongation Factor 1 alpha (JP452083) was used as internal standard. Three biological and three technical replicates were used for each qRT-PCR analysis. The threshold cycle (CT) was determined automatically, and the fold changes in expression for each gene of interest were calculated using the equation 2-ΔΔCt.

RNA sequencing and data analysis: The quality of the RNA isolated from hemp flowers was tested with a BioAnalyzer 2100 (Agilent, Santa Clara, CA), and samples with a RIN value greater the 8 were then used for RNA sequencing (Novogene, Sacramento, CA). The RNA was sequenced with one million reads per sample. Raw RNA-Seq reads were subjected to quality control and adapter trimming using TrimGalore and Trimmomatic with default parameters to remove low-quality bases and sequencing adapters. The quality of the filtered reads was assessed using FastQC. The high-quality reads were assembled de novo using Trinity with default parameters. Besides the internal control using the Trinity pipeline, the resulting transcriptome assembly was evaluated using BUSCO for completeness. Bowtie2 was used for read alignments that were quantified using RSEM. For the transcriptome annotation the generated transcriptome assembly was compared against the Cannabis sativa cv. Pink pepper genome assembly (ASM2916894v1, NCBI GenBank GCA_029168945.1) using BLASTX and BLASTN and a threshold E-value of <10-20. A complementary functional annotation of the transcriptome was generated using Trinotate. Differential gene expression analysis was performed using the DESeq2. A principal component analysis (PCA) plot was utilized to visualize and assess the clustering of the data. Genes were considered for further analysis only if they were defined to be significantly differentially expressed; if the value for Log₂ FC≥|2| with adjusted p-value (Padj) of ≤0.05.

Beet armyworm feeding assays: To determine the potential effects of individual cannabinoid compounds on the performance of beet armyworm (Spodoptera exigua) larvae, feeding assays on an artificial diet were performed. First-instar larvae were purchased from Benzon Research Inc. (Carlisle, PA, USA) and reared until they reached the second-instar stage. For the feeding assays powdered artificial insect diet (Benzon Research Inc.) was mixed with boiling water, stirred thoroughly, and allowed to solidify. The solidified diet was cut into rectangular cubes of 1 cm in length, 0.5 cm in width, and 0.5 cm in height. Pure individual cannabinoid compounds from the varinol, butol, olivetol, and phorol series (see above) were dissolved in acetonitrile and spread on the surface of diet cubes with a pipette. For each treatment, the cannabinoid concentration in the artificial diet was 0.01% w/w. As controls for the feeding assays either nothing or only the solvent acetonitrile was added to artificial diet cubes. To perform feeding assays one artificial diet cube was placed together with one second-instar larva in a petri dish. The weight of each larva was measured at the start of the assay and then every 48 h on day 2, 4, 6, and 8. To determine the survival rate, larvae were checked daily to see whether they were alive or dead until the emergence of adult insects.

Statistical analysis: Data collected from the analysis of cannabinoids and terpenes, and transcript levels of select genes have been analyzed using GraphPad Prism statistical software. A Student's t-test has been applied to compare the statistical significance of cannabinoids, and transcript levels between the control and treatment groups. For the insect feeding assay, two-way repeated-measure ANOVA was used to test the statistical difference between the controls and cannabinoid treatments.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Allen, K D et al. 2019. “Genomic Characterization of the Complete Terpene Synthase Gene Family from Cannabis Sativa.” PLOS ONE 14 (9): e0222363.
2. Aung, M M et al. 2000. “Influence of the N-1 Alkyl Chain Length of Cannabimimetic Indoles upon CB1 and CB2 Receptor Binding.” Drug and Alcohol Dependence 60 (2): 133-40.
3. Bergman, M E et al. 2024. “Plant Terpenoid Biosynthetic Network and Its Multiple Layers of Regulation.” Progress in Lipid Research 95 (July): 101287.
4. Booth, J K et al. 2017. “Terpene Synthases from Cannabis Sativa.” PLOS ONE 12 (3): e0173911.
5. Booth, J K et al. 2020. “Terpene Synthases and Terpene Variation in Cannabis Sativa.” Plant Physiology 184 (1): 130-47.
6. Braich, S et al. 2019. “Generation of a Comprehensive Transcriptome Atlas and Transcriptome Dynamics in Medicinal Cannabis.” Scientific Reports 9 (1): 16583.
7. Callaway, J. C. 2004. “Hempseed as a Nutritional Resource: An Overview.” Euphytica 140 (1-2): 65-72.
8. Casano, S., et al. 2011. “VARIATIONS IN TERPENE PROFILES OF DIFFERENT STRAINS OF CANNABIS SATIVA L.” Acta Horticulturae, no. 925 (December): 115-21.
9. Citti, C, et al. 2019. “A Novel Phytocannabinoid Isolated from Cannabis Sativa L. with an in Vivo Cannabimimetic Activity Higher than Δ9-Tetrahydrocannabinol: Δ9-Tetrahydrocannabiphorol.” Scientific Reports 9 (1): 20335.
10. Degenhardt, J et al. 2009. “Monoterpene and Sesquiterpene Synthases and the Origin of Terpene Skeletal Diversity in Plants.” Phytochemistry 70 (15-16): 1621-37.
11. Dowling, C A et al. 2021. “Timing Is Everything: The Genetics of Flowering Time in Cannabis Sativa.” The Biochemist 43 (3): 34-38. doi: 10.1042/bio_2021_138.
12. Fischedick, J T et al. 2010. “Metabolic Fingerprinting of Cannabis Sativa L., Cannabinoids and Terpenoids for Chemotaxonomic and Drug Standardization Purposes.” Phytochemistry 71 (17-18): 2058-73.
13. Fischedick, J T. 2017. “Identification of Terpenoid Chemotypes Among High (−)-Trans-Δ9-Tetrahydrocannabinol-Producing Cannabis Sativa L. Cultivars.” Cannabis and Cannabinoid Research 2 (1): 34-47.
14. Gagne, S J et al. 2012. “Identification of Olivetolic Acid Cyclase from Cannabis Sativa Reveals a Unique Catalytic Route to Plant Polyketides.” Proceedings of the National Academy of Sciences 109 (31): 12811-16.
15. Grof, C. P. L. 2018. “Cannabis, from Plant to Pill.” British Journal of Clinical Pharmacology 84 (11): 2463-67. doi: 10.1111/bcp.13618.
16. Günnewich, N et al. 2007. “Functional Expression and Characterization of Trichome-Specific (−)-Limonene Synthase and (+)-α-Pinene Synthase from Cannabis Sativa.” Natural Product Communications 2 (3): 1934578X0700200301.
17. Hillig, K W et al. 2004. “A Chemotaxonomic Analysis of Cannabinoid Variation in Cannabis (Cannabaceae).” American Journal of Botany 91 (6): 966-75.
18. Hurgobin, B et al. 2021. “Recent Advances in Cannabis Sativa Genomics Research.” New Phytologist 230(1):73-89. doi: 10.1111/nph.17140.
19. Jin, D et al. 2021. “Identification of Phenotypic Characteristics in Three Chemotype Categories in the Genus Cannabis.” doi: 10.21273/HORTSCI15607-20.
20. Karabourniotis, G et al. 2020. “Protective and Defensive Roles of Non-Glandular Trichomes against Multiple Stresses: Structure-Function Coordination.” Journal of Forestry Research 31 (1): 1-12. doi: 10.1007/s11676-019-01034-4.
21. Karus, M et al. 2004. “European Hemp Industry: Cultivation, Processing and Product Lines.” Euphytica 140 (1-2): 7-12.
22. Kessler, A et al. 2018. “Plant Secondary Metabolite Diversity and Species Interactions.” Annual Review of Ecology, Evolution, and Systematics 49 (1): 115-38.
23. Laverty, K U, et al. 2019. “A Physical and Genetic Map of Cannabis Sativa Identifies Extensive Rearrangements at the THC/CBD Acid Synthase Loci.” Genome Research 29 (1): 146-56.
24. Legare, C A et al. 2022. “Therapeutic Potential of Cannabis, Cannabidiol, and Cannabinoid-Based Pharmaceuticals.” Pharmacology 107(3-4):131-49. doi: 10.1159/000521683.
25. Li, H et al. 2020. “Overview of Cannabidiol (CBD) and Its Analogues: Structures, Biological Activities, and Neuroprotective Mechanisms in Epilepsy and Alzheimer's Disease.” European Journal of Medicinal Chemistry 192:112163. doi: 10.1016/j.ejmech.2020.112163.
26. Linciano, P, et al. 2020. “Isolation of a High-Affinity Cannabinoid for the Human CB1 Receptor from a Medicinal Cannabis Sativa Variety: Δ9-Tetrahydrocannabutol, the Butyl Homologue of Δ9-Tetrahydrocannabinol.” Journal of Natural Products 83 (1): 88-98.
27. Livingston, S J et al, et al. 2020. “Cannabis Glandular Trichomes Alter Morphology and Metabolite Content during Flower Maturation.” The Plant Journal 101 (1): 37-56.
28. Livingston, S J et al. 2020. “Cannabis Glandular Trichomes Alter Morphology and Metabolite Content during Flower Maturation.” The Plant Journal 101 (1): 37-56. doi: 10.1111/tpj. 14516.
29. Livingston, S J et al. 2021. “Cannabis Glandular Trichome Cell Walls Undergo Remodeling to Store Specialized Metabolites.” Plant and Cell Physiology 62 (12): 1944-62. doi: 10.1093/pcp/pcab127.
30. Livingston, S J et al. 2022. “A Polarized Supercell Produces Specialized Metabolites in Cannabis Trichomes.” Current Biology 32(18):4040-4047.e4. doi: 10.1016/j.cub.2022.07.014.
31. Luo, X et al, et al. 2019. “Complete Biosynthesis of Cannabinoids and Their Unnatural Analogues in Yeast.” Nature 567 (7746): 123-26.
32. Mantzoukas, S et al. 2020. “Larvicidal Action of Cannabidiol Oil and Neem Oil against Three Stored Product Insect Pests: Effect on Survival Time and in Progeny.” Biology 9(10):321. doi: 10.3390/biology9100321.
33. Mark, T et al. 2020. Economic Viability of Industrial Hemp in the United States: A Review of State Pilot Programs.
34. McPartland, J et al. 2001. “Cannabinoid Receptors Are Absent in Insects.” Journal of Comparative Neurology 436(4):423-29. doi: 10.1002/cne.1078.
35. McPartland, J M. 2017. “Cannabis Sativa and Cannabis Indica versus ‘Sativa’ and ‘Indica.” Pp. 101-21 in Cannabis sativa L.-Botany and Biotechnology, edited by S. Chandra, H. Lata, and M. A. ElSohly. Cham: Springer International Publishing.
36. Nadar, R M et al. 2022. “Cannabis-Based Cosmetic Products and Their Uses.” Pp. 253-69 in Cannabis/Marijuana for Healthcare, edited by D. C. Agrawal, R. Kumar, and M. Dhanasekaran. Singapore: Springer Nature.
37. Park, S-H et al. 2019. “Contrasting Roles of Cannabidiol as an Insecticide and Rescuing Agent for Ethanol-Induced Death in the Tobacco Hornworm Manduca Sexta.” Scientific Reports 9(1):10481. doi: 10.1038/s41598-019-47017-7.
38. Richins, R D et al. 2018. “Accumulation of Bioactive Metabolites in Cultivated Medical Cannabis.” PLOS ONE 13 (7): e0201119.
39. Rothschild, M et al. 1977. “Storage of Cannabinoids by Arctia Caja and Zonocerus Elegans Fed on Chemically Distinct Strains of Cannabis Sativa.” Nature 266 (5603): 650-51. doi: 10.1038/266650a0.
40. Rupasinghe, H. P. V. et al. 2020. “Industrial Hemp (Cannabis Sativa Subsp. Sativa) as an Emerging Source for Value-Added Functional Food Ingredients and Nutraceuticals.” Molecules 25(18):4078. doi: 10.3390/molecules25184078.
41. Russo, E B. 2007. “History of Cannabis and Its Preparations in Saga, Science, and Sobriquet.” Chemistry & Biodiversity 4 (8): 1614-48.
42. Sandler, L N et al. 2019. “Cannabis as Conundrum.” Crop Protection 117 (March): 37-44.
43 Schluttenhofer, C et al. 2017. “Challenges towards Revitalizing Hemp: A Multifaceted Crop.” Trends in Plant Science 22 (11): 917-29.
44. Sirikantaramas, S et al. 2017. “Cannabinoids: Biosynthesis and Biotechnological Applications.” Pp. 183-206 in Cannabis sativa L.—Botany and Biotechnology, edited by S. Chandra, H. Lata, and M. A. EISohly. Cham: Springer International Publishing.
45. Sirikantaramas, S, et al. 2004. “The Gene Controlling Marijuana Psychoactivity.” Journal of Biological Chemistry 279 (38): 39767-74.
46. Stout, J M et al. 2012. “The hexanoyl-CoA Precursor for Cannabinoid Biosynthesis Is Formed by an Acyl-activating Enzyme in Cannabis Sativa Trichomes.” The Plant Journal 71 (3): 353-65.
47. Tahir, M. N. et al. 2021. “The Biosynthesis of the Cannabinoids.” Journal of Cannabis Research 3(1):7. doi: 10.1186/s42238-021-00062-4.
48. Tanney, C. A. S., et al. 2021. “Cannabis Glandular Trichomes: A Cellular Metabolite Factory.” Frontiers in Plant Science 12. doi: 10.3389/fpls.2021.721986.
49. Tanney, C A S et al. 2021. “Cannabis Glandular Trichomes: A Cellular Metabolite Factory.” Frontiers in Plant Science 12 (September): 721986.
50. Taura, F et al, et al. 2009. “Characterization of Olivetol Synthase, a Polyketide Synthase Putatively Involved in Cannabinoid Biosynthetic Pathway.” FEBS Letters 583 (12): 2061-66.
51. Taura, F et al. 2007. “Cannabidiolic-acid Synthase, the Chemotype-determining Enzyme in the Fiber-type Cannabis Sativa.” FEBS Letters 581 (16): 2929-34.
52. Wanas, A et al. 2020. “Chemical Composition of Volatile Oils of Fresh and Air-Dried Buds of Cannabis c Hemovars, Their Insecticidal and Repellent Activities.” Natural Product Communications 15(5): 1934578X2092672. doi: 10.1177/1934578X20926729.
53. Welling, M T et al. 2022. “Biosynthetic Origins of Unusual Cannabimimetic Phytocannabinoids in Cannabis Sativa L: A Review.” Phytochemistry 201 (September): 113282.
54. Zager, J. J., et al. 2019. “Gene Networks Underlying Cannabinoid and Terpenoid Accumulation in Cannabis.” Plant Physiology 180 (4): 1877-97. doi: 10.1104/pp. 18.01506.
55. Zhou, Y et al. 2018. “Effects of Salt Stress on Plant Growth, Antioxidant Capacity, Glandular Trichome Density, and Volatile Exudates of Schizonepeta Tenuifolia Briq.” International Journal of Molecular Sciences 19(1):252.
56. Zirpel, B et al. 2018. “Elucidation of Structure-Function Relationship of THCA and CBDA Synthase from Cannabis Sativa L.” Journal of Biotechnology 284 (October): 17-26.
57. Zuardi, A W. 2006. “History of Cannabis as a Medicine: A Review.” Brazilian Journal of Psychiatry 28 (June): 153-57.

What is claimed is:

1. A pesticide composition comprising a minor cannabinoid and at least one excipient, diluent, surfactant, or carrier.

2. The pesticide composition of claim 1, wherein the minor cannabinoid comprises Δ⁹-tetrahydrocannabivarinic acid (Δ⁹-THCVA), Δ⁹-tetrahydrocannabivarin (Δ⁹-THCV), tetrahydrocannabivarinic acid (Δ⁸-THCVA), Δ⁸-tetrahydrocannabivarin (Δ⁸-THCV), tetrahydrocannabutol (Δ⁹-THCB), or any combination thereof.

3. The pesticide composition of claim 2, wherein the minor cannabinoid is Δ⁹-THCVA.

4. The pesticide composition of claim 2, wherein the minor cannabinoid is Δ⁹-THCV.

5. The pesticide composition of claim 2, wherein the minor cannabinoid is Δ⁸-THCVA.

6. The pesticide composition of claim 2, wherein the minor cannabinoid is Δ⁸-THCV.

7. The pesticide composition of claim 2, wherein the minor cannabinoid is Δ⁹-THCB.

8. The pesticide composition of claim 1, wherein the at least one excipient, diluent, surfactant, or carrier confers increased stability, wettability, dispersibility, or adherence to a substrate relative to a composition lacking the carrier.

9. The pesticide composition of claim 1, wherein the composition comprises an emulsion, a colloid, a granule, a pellet, a powder, a spray, a suspension, or a solution.

10. The pesticide composition of claim 1, wherein the at least one excipient, diluent, surfactant, or carrier comprises a solvent, an emulsifier, a buffer, a cryoprotectant, a salt, microbial culture medium, a wetting agent, a bulking agent, an anti-caking agent, a thickener, a clay, a mineral, a lipid, a gum, a dye or colorant, a biological waste material, or any combination thereof.

11. The pesticide composition of claim 1, wherein the composition further comprises an effective amount of at least one additional active ingredient.

12. The pesticide composition of claim 11, wherein the additional active ingredient comprises a fertilizer, a pesticide, an herbicide, or any combination thereof.

13. The pesticide composition of claim 12, wherein the additional active ingredient is a pesticide selected from the group consisting of neem oil, nicotine, a bacillus-based insecticide, pyrethrin, or a synthetic insecticide.

14. A method for reducing damage caused by an insect pest to a plant, the method comprising applying the pesticide composition of claim 1 to the plant or to at least one environmental component of the plant.

15. The method of claim 14, wherein the plant comprises an ornamental plant, a food plant, an energy crop, a fiber crop, a timber crop, or a combination thereof.

16. The method of claim 15, wherein the food plant comprises asparagus, bean, red garden beet, broccoli, cabbage, cauliflower, celery, chickpea, corn, cowpea, eggplant, lettuce, onion, pea, pepper, potato, radish, spinach, sweet potato, tomato, rice, sorghum, sugarcane, wheat, cotton, soybeans, barley, rye, oats, peanuts, sugar beets, grapes, alfalfa, turnip, or any combination thereof.

17. The method of claim 14, wherein the insect pest comprises beet armyworm, fall armyworms, African armyworm, true armyworm, yellow striped armyworms, southern armyworm, western yellow striped armyworms, grasshoppers, cabbage looper, tomato hornworms, diamondback moth, Japanese beetles, flea beetles, Colorado potato beetles, Mexican bean beetles, cucumber beetles, house flies, or any combination thereof.

18. The method of claim 14, wherein the at least one environmental component comprises leaf debris, soil, a rhizosphere of the plant, or any combination thereof.

19. The method of claim 14, wherein the composition is applied to one or more roots, leaves, fruits, flowers, stems, or seeds of the plant, or any combination thereof.

20. The method of claim 14, wherein the composition is applied to soil, compost, mulch, leaf litter, sawdust, straw, pine straw, wood chips, gravel, plant growing medium, or other material in a bed surrounding the plant.
